(19) United States
(12) Patent Application Publication
(10) Pub. No.: US 2023/0043591 A1
(43) Pub. Date: Feb. 9, 2023

(54) INFORMATION PROCESSING APPARATUS AND METHOD

(71) Applicant: SONY GROUP CORPORATION, Tokyo (JP)

(72) Inventors: Yuka KIYAMA, Tokyo (JP); Ryohei TAKAHASHI, Kanagawa (JP); Tsuyoshi ISHIKAWA, Kanagawa (JP); Mitsuhiro HIRABAYASHI, Tokyo (JP); Jun KIMURA, Kanagawa (JP); Hiroshi KUNO, Kanagawa (JP)

(73) Assignee: SONY GROUP CORPORATION, Tokyo (JP)

(21) Appl. No.: 17/790,680

(22) PCT Filed: Dec. 25, 2020
(86) PCT No.: PCT/JP2020/048726

§ 371 Date: Jul. 1, 2022

(30) Foreign Application Priority Data
Jan. 8, 2020 (JP) 2020-001412

(51) Int. Cl. G06T 19/00

(52) U.S. Cl. CPC G06T 19/00; G06T 2210/61; G06T 2219/028

(57) ABSTRACT

There is provided an information processing apparatus and method capable of more easily comparing 3D objects. Comparison information which is information for displaying a plurality of 3D objects of 6DoF content in a comparable manner is generated. Further, the plurality of 3D objects of the 6DoF content is displayed in a comparable manner on the basis of comparison information which is information for displaying the plurality of 3D objects in a comparable manner. The present disclosure can be applied to, for example, an information processing apparatus, an information processing method, an information processing system, and the like.

### TECHNICAL FIELD

The present disclosure relates to an information processing apparatus and method, and more particularly, to an information processing apparatus and method capable of more easily comparing 3D objects.

### BACKGROUND ART

Conventionally, distribution of three-dimensional content (also referred to as 3D content) representing a three-dimensional object (also referred to as 3D object) in a three-dimensional space (also referred to as 3D space) has been proposed. Further, as the 3D content, for example, 6DoF content has been proposed in which a three-dimensional object in a three-dimensional space is represented and a line-of-sight direction and a viewpoint position can be freely set at the time of reproduction.

As a method of distributing 6DoF content, for example, a method of configuring a 3D space with a plurality of 3D objects and transmitting the 3D space as a plurality of object streams has been proposed. Then, at that time, for example, it has been proposed to use a description method called scene description (see, for example, Non-Patent Document 1).

### CITATION LIST

### Non-Patent Document

Non-Patent Document 1: “ISO/IEC 14496-11”, Second Edition, 2015-05-29

### SUMMARY OF THE INVENTION

### Problems to be Solved by the Invention

However, in this description method, it is not possible to describe information regarding a method of arranging two 3D objects (3D objects) included in each of a plurality of 6DoF content side by side or superimposing the 3D objects on each other and reproducing the 3D objects at the same timing to display both objects in a comparable manner. Therefore, in a case of displaying such a plurality of objects in a comparable manner, complicated work for reproduction control by a user or the like is required.

The present disclosure has been made in view of such a situation, and is to compare 3D objects more easily.

### Solutions to Problems

An information processing apparatus according to one aspect of the present technology is an image processing apparatus including a comparison information generation unit that generates comparison information which is information for displaying a plurality of 3D objects of 6DoF content in a comparable manner.

An information processing method according to one aspect of the present technology is an image processing method for generating comparison information which is information for displaying a plurality of 3D objects of 6DoF content in a comparable manner.

In the information processing apparatus and method according to one aspect of the present technology, comparison information that is information for displaying a plurality of 3D objects of 6DoF content in a comparable manner is generated.

### BRIEF DESCRIPTION OF DRAWINGS

FIG. 1 is a block diagram illustrating a main configuration example of an information processing system.

FIG. 2 is a block diagram illustrating a main configuration example of a generation device.

FIG. 3 is a block diagram illustrating a main configuration example of a client device.

FIG. 4 is a diagram illustrating a main configuration example of distribution data of 6DoF content.

FIG. 5 is a diagram illustrating a comparable display example of a 3D object.

FIG. 6 is a diagram illustrating a signal example of comparison information.

FIG. 7 is a diagram illustrating an example of an MPD including comparison information.

FIG. 8 is a flowchart illustrating an example of a flow of a file generation process.

FIG. 9 is a flowchart illustrating an example of a flow of a reproduction process.

FIG. 10 is a diagram illustrating a comparable display example of a 3D object.

FIG. 11 is a diagram illustrating a signal example of comparison information.

FIG. 12 is a diagram illustrating a comparable display example of a 3D object.

FIG. 13 is a diagram illustrating a signal example of comparison information.

FIG. 14 is a diagram illustrating a main configuration example of distribution data of 6DoF content.

FIG. 15 is a diagram illustrating a signal example of comparison information.

FIG. 16 is a diagram illustrating an example of an MPD including comparison information.

FIG. 17 is a flowchart illustrating an example of a flow of a reproduction process.

FIG. 18 is a diagram illustrating a main configuration example of distribution data of 6DoF content.

FIG. 19 is a diagram illustrating a signal example of comparison information.

FIG. 20 is a diagram illustrating an example of an MPD including comparison information.

FIG. 21 is a flowchart illustrating an example of a flow of a reproduction process.

FIG. 22 is a diagram illustrating a main configuration example of distribution data of 6DoF content.

FIG. 23 is a diagram illustrating a signal example of comparison information.

FIG. 24 is a diagram illustrating an example of an MPD including comparison information.

FIG. 25 is a flowchart illustrating an example of a flow of a reproduction process.

FIG. 26 is a diagram illustrating an example of a comparison scenario at the time of normal viewing.

FIG. 27 is a diagram illustrating a signal example of comparison information.

FIG. 28 is a diagram illustrating an example of an MPD including comparison information.

FIG. 29 is a flowchart illustrating an example of a flow of a reproduction process.

FIG. 30 is a flowchart subsequent to FIG. 29 for describing an example of a flow of a reproduction process.

FIG. 31 is a diagram illustrating a main configuration example of ISOBMFF.

FIG. 32 is a diagram illustrating a signal example of comparison information.

FIG. 33 is a diagram illustrating a signal example of comparison information.

FIG. 34 is a conceptual diagram illustrating a signal example of comparison display information that changes with time.

FIG. 35 is a conceptual diagram illustrating a signal example of comparison display information that changes with time.

FIG. 36 is a diagram illustrating a signal example of comparison information.

FIG. 37 is a block diagram illustrating a main configuration example of a computer.

### MODE FOR CARRYING OUT THE INVENTION

Hereinafter, modes for carrying out the present disclosure (hereinafter referred to as embodiments) will be described. Note that the description will be given in the following order.

1. Documents Supporting Technical Contents and Technical Terms

2. Signaling of Comparison Information

3. First Embodiment (Signaling of Comparison Information for Each Scene Description)

4. Second Embodiment (Signaling of Comparison Information Corresponding to Plurality of Scene Descriptions)

5. Third Embodiment (Signaling of Comparison Viewing Method Information)

6. Fourth Embodiment (Signaling of Information Related to Thumbnail)

7. Fifth Embodiment (Signaling of Comparison Display Information That Changes Dynamically)

8. Appendix

### 1. Documents Supporting Technical Contents and Technical Terms

The scope disclosed in the present technology includes not only the contents described in the examples but also the contents described in the following non-patent documents known at the time of filing.
Non-Patent Document 1: (described above)
Non-Patent Document 2: ISO/IEC 14496-12: 2015, Information technology. Coding of audio-visual objects. Part 12, ISO base media file format
Non-Patent Document 3: ISO/IEC 23009-1: 2014, Information technology, Dynamic adaptive streaming over HTTP (DASH), Part 1, Media presentation description and segment formats
Non-Patent Document 4: Khronos glTF 2.0, Khronos glTF 2.0, https://github.com/KhronosGroup/glTF/tree/master/specification/2.0

That is, the content described in the above-described non-patent document also serves as a basis for determining the support requirement. For example, the structure/term used in the file structure described in Non-Patent Document 2, the terms used in the MPEG-DASH standard described in Non-Patent Document 3, and the “camera” object, the “animation” object, and the like described in Non-Patent Document 4 are within the scope of the present disclosure and satisfy the support requirements of the claims even if they are not directly defined in the present specification. Further, for example, even in a case where technical terms such as parsing, syntax, and semantics are not directly defined in the present specification, the technical terms fall within the scope of the present disclosure and satisfy the support requirements of the claims.

### 2. Signaling of Comparison Information

In current video distribution, distribution of content (also referred to as 2D content) including a two-dimensional video used for distribution of a movie or the like is mainstream. Further, content (also referred to as 3DoF content) including a 360-degree video (also referred to as a 3-degree-of-freedom (3DoF) video) that can be viewed in all directions is also distributed. In both the 2D content and the 3DoF content, a video that is basically two-dimensionally encoded is distributed and displayed on the client. Further, 3DoF+ content is content that can be looked around in all directions as in the above-described 3DoF content and can slightly move the viewpoint position. The movable range of the viewpoint position is assumed to be a degree to which the head can be moved in a seated state. In this 3DoF+ content, movement of the viewpoint position is realized by using a single or a plurality of videos encoded two-dimensionally.

The 6DoF content is content that can be looked around in all directions in a three-dimensional space (also referred to as a 3D space) (line-of-sight direction can be freely set) and can be moved in the space (viewpoint position can be freely set). The video which is included in the 6DoF content and in which the viewpoint position and the line-of-sight direction can be freely set as described above is also referred to as a 6DoF video. For example, in the case of such 6DoF content, it is possible to focus on a certain 3D object included in the content and change the viewpoint position and the line-of-sight direction so as to view the 3D object from the surroundings.

Further, for example, it is possible to realize a viewing experience in which a 3D object included in a certain 6DoF content and a 3D object included in another 6DoF content are displayed side by side or superimposed on each other, and reproduced at the same timing, and movements of both objects are compared as seen from the surroundings. For example, in sports content and the like, it is possible to realize a viewing experience of comparing motions (a pitching form, a batting form, and the like) of two famous players in a form of being viewed from the surroundings.

By the way, as a method of distributing 6DoF content, for example, a method of configuring a 3D space with a plurality of 3D objects and transmitting the 3D space as a plurality of object streams has been proposed. Then, for example, in Non-Patent Document 1, it has been proposed to use a description method called scene description.

However, in this description method, it is not possible to describe information about a method of displaying the 3D object in a comparable manner as described above. Therefore, in the case of displaying such a plurality of objects in a comparable manner, complicated work for reproduction control by the user or the like is required, such as selecting two comparable contents, matching the reproduction timings of the contents, or performing adjustment so that the appearance of each content is the same. In particular, in the case of 6DoF content, due to the high degree of freedom that the content can be viewed from any position, adjustment for comparison may require more complicated work.

For example, in the case of Multivideo (https://dotapps.jp/products/com-tattin-multivideo-0002), two moving images can be selected from existing content, arranged side by side or superimposed on each other, and reproduced simultaneously in order to compare changes in two motions or forms. However, the content to be compared in this application is a two-dimensional image, and it is not possible to compare 3D objects of 6DoF content. Further, in order to reproduce the comparison target contents at the same time, it is necessary for the user to perform complicated work such as selecting comparison target contents and specifying a reproduction timing, a region and a size of each video.

None of Non-Patent Documents 1 to 4 described above discloses a method of describing information regarding a method of displaying 3D objects in a comparable manner.

Therefore, comparison information that is information for displaying a plurality of 3D objects of 6DoF content in a comparable manner is generated. By signaling such comparison information (that is, transmitting the content to the reproduction side of the content), it is possible to more easily compare 3D objects without requiring complicated work for the comparison as described above.

### 3. First Embodiment

<Signaling of Comparison Information for Each Scene Description>

In the present embodiment, a method of signaling the comparison information for each scene description will be described.

<Information Processing System>

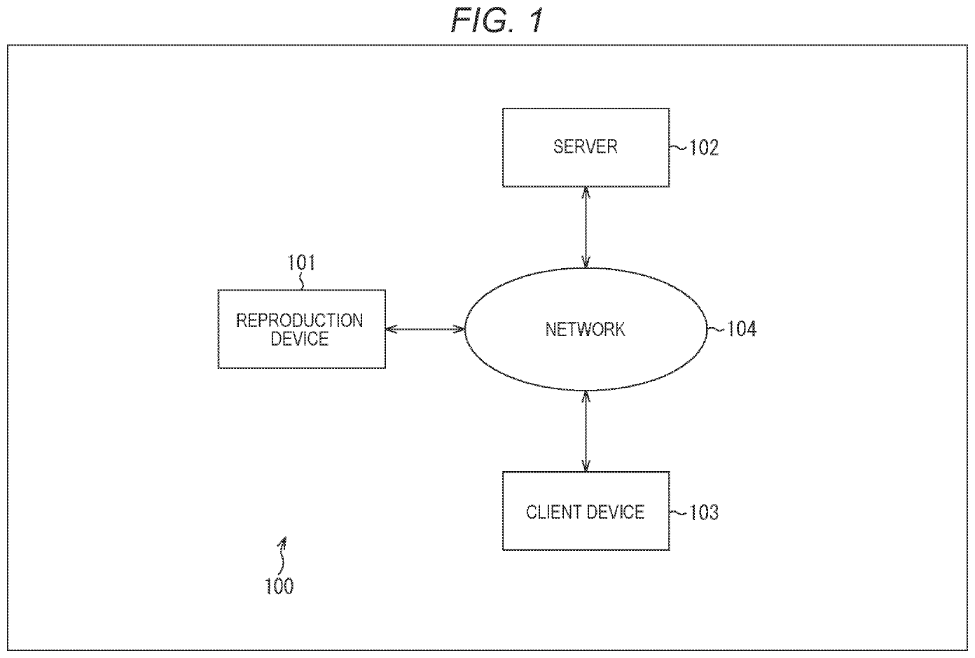

FIG. 1 is a block diagram illustrating an example of a configuration of a distribution system which is an aspect of an information processing system to which the present technology is applied. A distribution system 100 illustrated in FIG. 1 is a system that distributes 6DoF content.

As illustrated in FIG. 1, the distribution system 100 includes a generation device 101, a server 102, and a client device 103. The generation device 101, the server 102, and the client device 103 are communicably connected to each other via a network 104. Note that, in FIG. 1, each device is illustrated only one, but the distribution system 100 may have any numbers of respective devices. That is, a plurality of generation devices 101, a plurality of servers 102, and a plurality of client devices 103 may be provided.

The generation device 101 performs processing related to generation of 6DoF content. For example, the generation device 101 can generate media data that is data such as a 6DoF video, a scene description that is metadata of the media data, a media presentation description (MPD) of Dynamic Adaptive Streaming over HTTP (DASH), ISO/IEC 23009-1, and the like. Further, the generation device 101 can supply (upload) the generated data to the server 102 via the network 104.

The server 102 performs processing related to distribution of 6DoF content. For example, the server 102 can acquire data of the above-described 6DoF content supplied from the generation device 101. Further, the server 102 can provide a service for managing the acquired data and distributing 6DoF content. For example, the server 102 can distribute data of 6DoF content (MPD, scene description, media data, and the like) to the client device 103 or the like via the network 104 in response to a request from the client device 103 or the like.

The client device 103 performs processing related to reproduction of 6DoF content. For example, the client device 103 may request the server 102 to provide 6DoF content via the network 104. Further, the client device 103 can acquire the data of 6DoF content (MPD, scene description, media data, and the like) distributed from the server 102 in response to the request via the network 104. Moreover, the client device 103 may reproduce the acquired 6DoF content. For example, the client device 103 can perform rendering to generate an image of a desired viewpoint position and line-of-sight direction, and display the image on the monitor.

The network 104 is a communication network including an arbitrary communication medium.

Communication performed via the network 104 may be wired communication, wireless communication, or both. That is, the network 104 may be a communication network for wired communication, a communication network for wireless communication, or a communication network including both of them. Further, the network 104 may include a single communication network or a plurality of communication networks.

For example, the Internet may be included in the network 104. Further, a public telephone network may be included in the network 104. In addition, a wide-area communication network for a wireless mobile body such as a so-called 3G line or a 4G line may be included in the network 104. Moreover, a wide area network (WAN), a local area network (LAN), or the like may be included in the network 104. Further, the network 104 may include a wireless communication network that performs communication conforming to the Bluetooth (registered trademark) standard. Moreover, a communication path of short-range wireless communication such as near field communication (NFC) may be included in the network 104. Furthermore, a communication path for infrared communication may be included in the network 104. In addition, a communication network for wired communication conforming to a standard such as High-Definition Multimedia Interface (HDMI) (registered trademark) or Universal Serial Bus (USB) (registered trademark) may be included in the network 104. As described above, the network 104 may include a communication network or a communication path of an arbitrary communication standard.

In the distribution system 100 that distributes such 6DoF content, the client device 103 can arrange 3D objects of a plurality of 6DoF content side by side or superimpose them on each other and reproduce and display the 3D objects in a comparable manner. Then, the generation device 101 generates and signals comparison information that is information for performing such comparable display of the 3D object. The client device 103 performs the above-described reproduction and display on the basis of the comparison information. As a result, the user of the client device 103 can more easily compare the 3D objects without requiring complicated work.

<Generation Device>

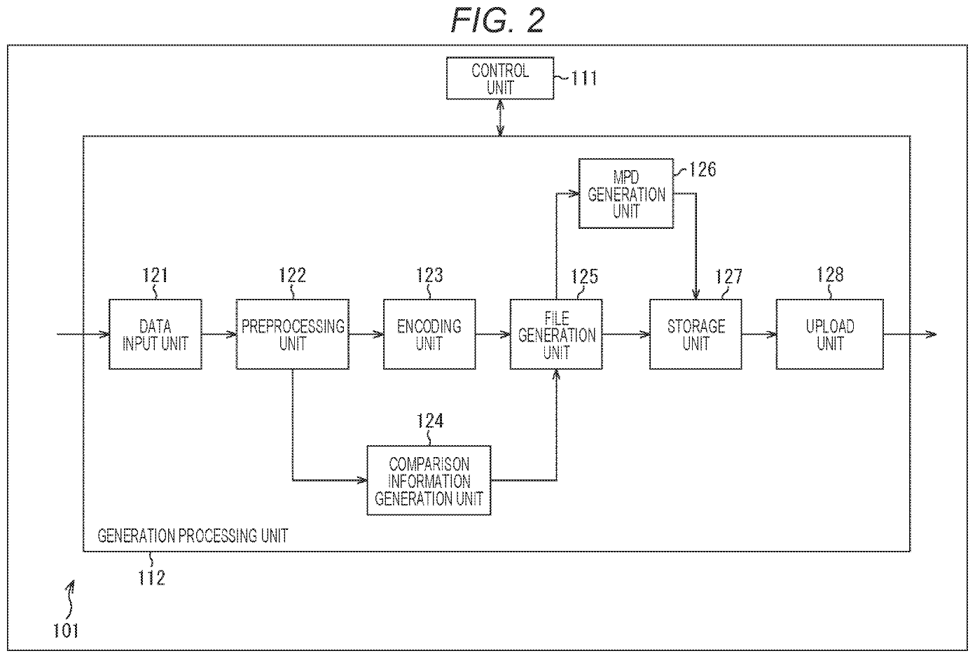

FIG. 2 is a block diagram illustrating a main configuration example of the generation device 101. Note that, in FIG. 2, main configurations such as processing units, data flows, and the like are illustrated, and those illustrated in FIG. 2 are not necessarily all. That is, in the generation device 101, there may be a processing unit not illustrated as a block in FIG. 2, or there may be processing or a data flow not illustrated as an arrow or the like in FIG. 2. As illustrated in FIG. 2, the generation device 101 includes a control unit 111 and a generation processing unit 112.

The control unit 111 performs processing related to control of the generation processing unit 112. The generation processing unit 112 is controlled by the control unit 111 and performs processing related to generation of data of 6DoF content. As illustrated in FIG. 2, the generation processing unit 112 includes a data input unit 121, a preprocessing unit 122, an encoding unit 123, a comparison information generation unit 124, a file generation unit 125, an MPD generation unit 126, a storage unit 127, and an upload unit 128.

The data input unit 121 performs processing related to input of media data. For example, the data input unit 121 can receive media data and a scene description input from the outside (for example, another device) and supply the media data and the scene description to the preprocessing unit 122. Note that the data input unit 121 may generate media data or scene descriptions of 6DoF content. For example, the data input unit 121 may include a camera or the like, image a subject with the camera or the like, generate media data from the captured image, and further generate a scene description corresponding to the media data.

The preprocessing unit 122 performs processing related to preprocessing on media data. For example, the preprocessing unit 122 can acquire the media data and scene descriptions supplied from the data input unit 121. Further, the preprocessing unit 122 can appropriately perform image processing and the like on the acquired media data and appropriately edit the scene description. Note that the data input unit 121 may supply the media data to the preprocessing unit 122, and the preprocessing unit 122 may generate a scene description corresponding to the media data. Further, the preprocessing unit 122 can supply the media data and the scene description to the encoding unit 123 and the comparison information generation unit 124.

The encoding unit 123 performs processing related to encoding. For example, the encoding unit 123 can acquire the media data and scene descriptions supplied from the preprocessing unit 122. Moreover, the encoding unit 123 can encode the media data to generate encoded data. Note that this encoding method is arbitrary. Further, the encoding unit 123 can supply the scene description and the generated encoded data of the generated media data to the file generation unit 125.

The comparison information generation unit 124 performs processing related to generation of comparison information that is information for reproducing and displaying a 3D object in a comparable manner. For example, the comparison information generation unit 124 can acquire the media data and scene descriptions supplied from the preprocessing unit 122. Further, the comparison information generation unit 124 can generate comparison information on the basis of the data. Moreover, the comparison information generation unit 124 can supply the generated comparison information to the file generation unit 125.

The file generation unit 125 performs processing related to generation of a file that collects the data of 6DoF content. For example, the file generation unit 125 can acquire the encoded data and the scene description of the media data supplied from the encoding unit 123. Further, the file generation unit 125 can acquire the comparison information supplied from the comparison information generation unit 124. Moreover, the file generation unit 125 can convert the data into a file, that is, generate a file including the data. At that time, the file generation unit 125 may include the comparison information in the scene description. That is, the file generation unit 125 may generate a file including the encoded data of media data and the scene description including the comparison information. Further, the file generation unit 125 can supply the generated file to the MPD generation unit 126 and the storage unit 127.

The MPD generation unit 126 performs processing related to the generation of the MPD. For example, the MPD generation unit 126 can acquire the file supplied from the file generation unit 125. Further, the MPD generation unit 126 can generate the MPD corresponding to the file (media data, scene description, comparison information, and the like stored in the file) on the basis of the media data, the scene description, the comparison information, and the like stored in the file. For example, the MPD generation unit 126 can generate an MPD including comparison information. Further, the MPD generation unit 126 can supply the generated MPD to the storage unit 127.

The storage unit 127 performs processing related to storage of 6DoF content. For example, the storage unit 127 can acquire the file supplied from the file generation unit 125. Further, the storage unit 127 can store the acquired file. In addition, the storage unit 127 can acquire the MPD supplied from the MPD generation unit 126. Moreover, the storage unit 127 can store the acquired MPD. Furthermore, the storage unit 127 can supply the stored file or MPD to the upload unit 128 at a predetermined timing or in response to a predetermined event, request, or the like.

The upload unit 128 performs processing related to upload of 6DoF content. For example, the upload unit 128 can acquire the file or MPD supplied from the storage unit 127. Moreover, the upload unit 128 can communicate with the server 102 via the network 104 and transmit (upload) the acquired file and MPD to the server 102.

As described above, in the generation device 101, the comparison information generation unit 124 generates the comparison information. In this way, the file generation unit 125 can convert the comparison information into a file. Further, the MPD generation unit 126 can generate an MPD reflecting the comparison information. Moreover, the upload unit 128 can upload a file including the comparison information and an MPD reflecting the comparison information. That is, the comparison information can be signaled. Therefore, the user of the client device 103 can more easily compare the 3D objects.

Note that each of these processing units (the data input unit 121 to the upload unit 128) of the generation device 101 has an arbitrary configuration. For example, each processing unit may be configured by a logic circuit that realizes the above-described processing. Further, each processing unit may include, for example, a central processing unit (CPU), a read only memory (ROM), a random access memory (RAM), and the like, and execute a program using the CPU, the ROM, the RAM, and the like, thereby implementing the above-described processing. Of course, each processing unit may have both configurations, and a part of the above-described processing may be realized by a logic circuit and the other may be realized by executing a program. The configurations of the processing units may be independent from each other. For example, some processing units may implement a part of the above-described processing by a logic circuit, some other processing units may implement the above-described processing by executing a program, and other processing units may implement the above-described processing by both the logic circuit and the execution of the program.

<Client Device>

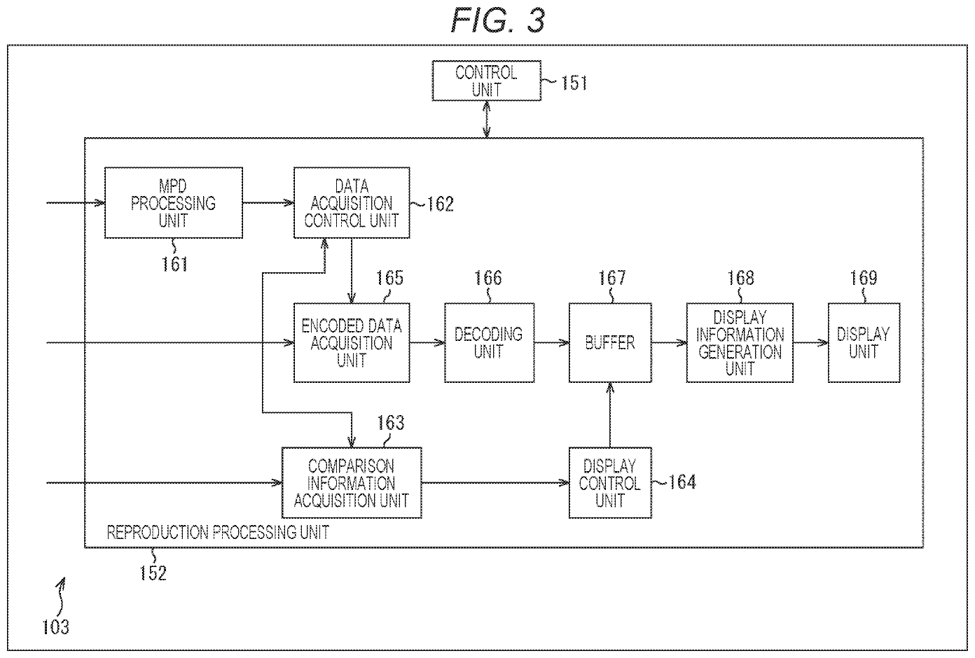

FIG. 3 is a block diagram illustrating a main configuration example of the client device 103. Note that, in FIG. 3, main processing units, data flows, and the like are illustrated, and those illustrated in FIG. 3 are not necessarily all. That is, in the client device 103, there may be a processing unit not illustrated as a block in FIG. 3, or there may be processing or a data flow not illustrated as an arrow or the like in FIG. 3. As illustrated in FIG. 3, the client device 103 includes a control unit 151 and a reproduction processing unit 152. The control unit 151 performs processing related to control of the reproduction processing unit 152. The reproduction processing unit 152 is controlled by the control unit 151 to perform processing related to reproduction of 6DoF content. As illustrated in FIG. 3, the reproduction processing unit 152 includes an MPD processing unit 161, a data acquisition control unit 162, a comparison information acquisition unit 163, a display control unit 164, an encoded data acquisition unit 165, a decoding unit 166, a buffer 167, a display information generation unit 168, and a display unit 169.

The MPD processing unit 161 performs processing related to the MPD. For example, the MPD processing unit 161 can acquire an MPD corresponding to desired 6DoF content designated by a user, an application, or the like. For example, the MPD processing unit 161 can communicate with the server 102 via the network 104, request the server 102 for the MPD corresponding to the desired 6DoF content, and acquire the MPD supplied in response to the request. Moreover, the MPD processing unit 161 can parse the acquired MPD and supply the result to the data acquisition control unit 162.

The data acquisition control unit 162 performs processing related to control of 6DoF content acquisition. For example, the data acquisition control unit 162 can acquire the parsing result of the MPD supplied from the MPD processing unit 161. Further, the data acquisition control unit 162 can control acquisition of the comparison information and the scene description, and acquisition of the encoded data of the media data on the basis of the parsing result (that is, the content of the MPD). For example, the data acquisition control unit 162 can control the comparison information acquisition unit 163 to control which comparison information or scene description is to be acquired. Further, the data acquisition control unit 162 can acquire the comparison information acquired by the comparison information acquisition unit 163. Moreover, the data acquisition control unit 162 can control the encoded data acquisition unit 165 on the basis of the parsing result (that is, the content of the MPD) of the MPD and the comparison information, and can control which 6DoF content's encoded data is to be acquired.

The comparison information acquisition unit 163 performs processing related to acquisition of comparison information. For example, the comparison information acquisition unit 163 can acquire the comparison information corresponding to the MPD acquired by the MPD processing unit 161 according to the control of the data acquisition control unit 162. For example, the comparison information acquisition unit 163 can communicate with the server 102 via the network 104, request the server 102 for desired comparison information designated by the data acquisition control unit 162, and acquire the comparison information supplied in response to the request. Note that the comparison information acquisition unit 163 can similarly acquire the scene description corresponding to the comparison information. For example, in a case where the comparison information is included in the scene description, the comparison information acquisition unit 163 can similarly acquire the scene description including the comparison information. Further, the comparison information acquisition unit 163 can supply the acquired comparison information (or scene description) to the data acquisition control unit 162 or the display control unit 164.

The display control unit 164 performs processing related to control of display of 6DoF content. For example, the display control unit 164 can acquire the comparison information (or scene description) supplied from the comparison information acquisition unit 163. Further, on the basis of the comparison information (or scene description), the display control unit 164 can generate display control information for controlling reproduction and display of the 6DoF content so as to reproduce and display the 3D objects in a comparable manner, and supply the display control information to the buffer 167.

The encoded data acquisition unit 165 performs processing related to acquisition of encoded data. For example, the encoded data acquisition unit 165 can acquire the encoded data of the media data corresponding to the MPD acquired by the MPD processing unit 161 and the comparison information (or scene description) acquired by the comparison information acquisition unit 163 according to the control of the data acquisition control unit 162. That is, for example, the encoded data acquisition unit 165 can acquire the encoded data of the media data of the comparison target 3D object. For example, the encoded data acquisition unit 165 communicates with the server 102 via the network 104, requests the server 102 for the data of desired 6DoF content designated by the data acquisition control unit 162, and can acquire encoded data supplied in response to the request. Moreover, the encoded data acquisition unit 165 can supply the acquired encoded data to the decoding unit 166.

The decoding unit 166 performs processing related to decoding of encoded data. For example, the decoding unit 166 can acquire the encoded data of the media data supplied from the encoded data acquisition unit 165. Further, the decoding unit 166 decodes the encoded data to generate (restore) media data. Note that this decoding method is arbitrary as long as the decoding method is compatible with the encoding method of the encoding unit 123. Further, the decoding unit 166 can supply the generated (restored) media data to the buffer 167.

The buffer 167 performs processing related to data holding. For example, the buffer 167 can acquire and hold the media data supplied from the decoding unit 166. Further, the buffer 167 can acquire and hold the display control information supplied from the display control unit 164. Further, the buffer 167 can supply the held information to the display information generation unit 168 at a predetermined timing or in response to a predetermined event, request, or the like.

The display information generation unit 168 performs processing related to generation of display information that is data of an image to be displayed, metadata thereof, or the like. For example, the display information generation unit 168 can read and acquire media data, display control information, and the like held in the buffer 167. Further, the display information generation unit 168 can generate the display information on the basis of the data read from the buffer 167. Further, the display information generation unit 168 can supply the generated display information to the display unit 169.

The display unit 169 includes a monitor, and performs processing related to display using the monitor. For example, the display unit 169 can acquire the display information supplied from the display information generation unit 168. Further, the display unit 169 can display the display information on the monitor.

As described above, in the client device 103, the comparison information acquisition unit 163 acquires the comparison information, and the display control unit 164 generates the display control information on the basis of the comparison information. That is, the display control unit 164 controls the display of the 6DoF content so as to display a plurality of 3D objects of the 6DoF content in a comparable manner. In this way, the display information generation unit 168 can generate the display information for displaying the plurality of 3D objects of the 6DoF content in a comparable manner on the basis of the display control information, and can display the display information on the display unit 169. That is, the display unit 169 can display a plurality of 3D objects of 6DoF content in a comparable manner. In this way, the client device 103 can more easily reproduce and display a plurality of 3D objects in a comparable manner on the basis of the signaled comparison information. That is, the user can more easily compare the 3D objects.

Note that each of these processing units (the MPD processing unit 161 to the display unit 169) of the client device 103 has an arbitrary configuration. For example, each processing unit may be configured by a logic circuit that realizes the above-described processing. Further, each processing unit may include, for example, a CPU, a ROM, a RAM, and the like, and execute a program using the CPU, the ROM, the RAM, and the like, thereby implementing the above-described processing. Of course, each processing unit may have both configurations, and a part of the above-described processing may be realized by a logic circuit and the other may be realized by executing a program. The configurations of the processing units may be independent from each other. For example, some processing units may implement a part of the above-described processing by a logic circuit, some other processing units may implement the above-described processing by executing a program, and other processing units may implement the above-described processing by both the logic circuit and the execution of the program.

<Distribution Data>

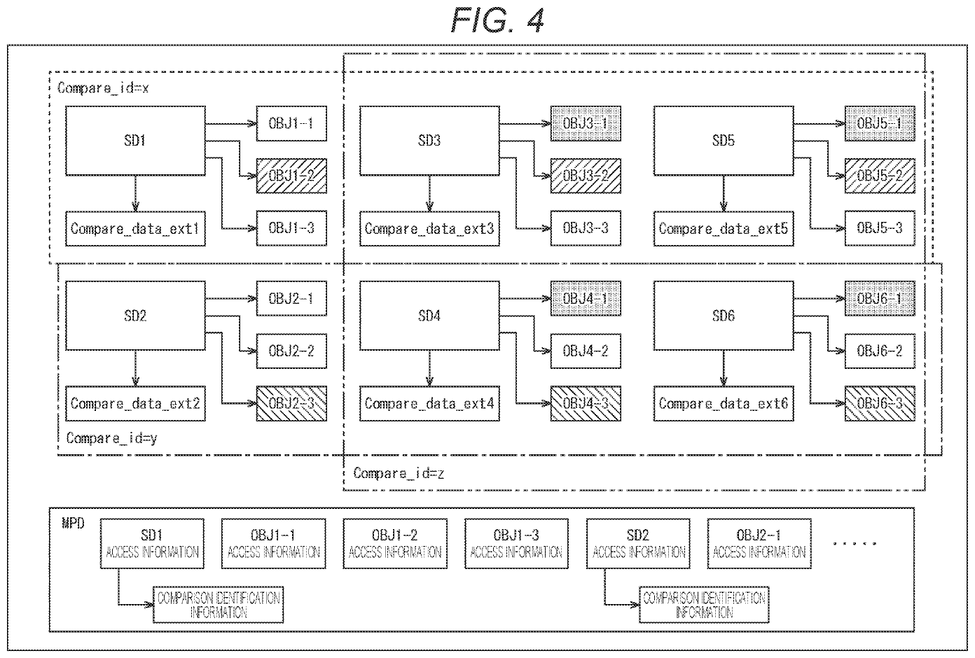

Next, data of 6DoF content will be described. The generation device 101 generates, for example, data as illustrated in FIG. 4 as the data of 6DoF content. FIG. 4 is a diagram illustrating an example of distribution data distributed as 6DoF content.

In the example of FIG. 4, the distribution data includes media data of 18 3D objects (OBJ1-1 to OBJ1-3, OBJ2-1 to OBJ2-3, OBJ3-1 to OBJ3-3, OBJ4-1 to OBJ4-3, OBJ5-1 to OBJ5-3, OBJ6-1 to OBJ6-3). These 3D objects are 3D objects different from each other.

Further, in the case of the example of FIG. 4, the distribution data includes six scene descriptions (SD1 to SD6). SD1 is a scene description corresponding to media data of three 3D objects (OBJ1-1, OBJ1-2, OBJ1-3). SD2 is a scene description corresponding to media data of three 3D objects (OBJ2-1, OBJ2-2, OBJ2-3). SD3 is a scene description corresponding to media data of three 3D objects (OBJ3-1, OBJ3-2, OBJ3-3). SD4 is a scene description corresponding to media data of three 3D objects (OBJ4-1, OBJ4-2, OBJ4-3). SD5 is a scene description corresponding to media data of three 3D objects (OBJ5-1, OBJ5-2, OBJ5-3). SD6 is a scene description corresponding to media data of three 3D objects (OBJ6-1, OBJ6-2, OBJ6-3).

Further, in the case of the example of FIG. 4, the distribution data includes comparison information for each scene description. Compare_data_ext1 is comparison information corresponding to SD1. Compare_data_ext2 is comparison information corresponding to SD2. Compare_data_ext3 is comparison information corresponding to SD3. Compare_data_ext4 is comparison information corresponding to SD4. Compare_data_ext5 is comparison information corresponding to SD5. Compare_data_ext6 is comparison information corresponding to SD6.

Further, in the case of the example of FIG. 4, the distribution data includes the MPD corresponding to these pieces of data. That is, the MPD includes information (SD1 access information, SD2 access information, SD3 access information, SD4 access information, SD5 access information, and SD6 access information) for accessing each scene description. Further, the MPD includes information (OBJ1-1 access information, OBJ1-2 access information, OBJ1-3 access information, OBJ2-1 access information, OBJ2-2 access information, OBJ2-3 access information, OBJ3-1 access information, OBJ3-2 access information, OBJ3-3 access information, OBJ4-1 access information, OBJ4-2 access information, OBJ4-3 access information, OBJ5-1 access information, OBJ5-2 access information, OBJ5-3 access information, OBJ6-1 access information, OBJ6-2 access information, and OBJ6-3 access information) for accessing media data of each 3D object.

<Comparison Identification Information>

The comparison information (Compare_data_ext1 to Compare_data_ext6) may include comparison identification information that is information regarding the comparison target 3D object. For example, the comparison information includes, as the comparison identification information, identification information (compare id) of media data of a comparable 3D object and a group of scene descriptions (also referred to as a comparable group) corresponding to the 3D object. That is, “compare id” is information indicating the comparable group.

For example, in the example of FIG. 4, the 3D objects indicated by the diagonal line pattern hatched in the upper-right-to-lower-left direction in the drawing indicate objects that can be compared with each other. That is, OBJ1-2, OBJ3-2, and OBJ5-2 can be reproduced and displayed in a comparable manner. Therefore, as indicated by a dotted frame, SD1, SD3, SD5, OBJ1-2, OBJ3-2, and OBJ5-2 are in a comparable group x, and “x” is allocated as a compare id (Compare_id=x). That is, the comparison information corresponding to those scene descriptions, that is, Compare_data_ext1, Compare_data_ext3, and Compare_data_ext5 include “Compare_id=x” indicating the comparable group x as the comparison identification information.

Further, in the example of FIG. 4, the 3D objects indicated by the diagonal line pattern hatched in the lower-right-to-upper-left direction in the drawing indicate objects that can be compared with each other. That is, OBJ2-3, OBJ4-3, and OBJ6-3 can be reproduced and displayed in a comparable manner. Therefore, as indicated by a one-dot chain line frame, SD2, SD4, SD6, OBJ2-3, OBJ4-3, and OBJ6-3 are in a comparable group y, and “y” is allocated as a compare id (Compare_id=y). That is, the comparison information corresponding to those scene descriptions, that is, Compare_data_ext2, Compare_data_ext4, and Compare_data_ext6 include “Compare_id=y” indicating the comparable group y as the comparison identification information.

Further, in the example of FIG. 4, the 3D objects illustrated in gray indicate objects that can be compared with each other. That is, OBJ3-1, OBJ4-1, OBJ5-1, and OBJ6-1 can be reproduced and displayed in a comparable manner. Therefore, as indicated by a two-dot chain line frame, SD3, SD4, SD5, SD6, OBJ3-1, OBJ4-1, OBJ5-1, and OBJ6-1 are in a comparable group z, and “z” is allocated as a compare id (Compare_id=z). That is, the comparison information corresponding to those scene descriptions, that is, Compare_data_ext3, Compare_data_ext4, Compare_data_ext5, and Compare_data_ext6 include “Compare_id=z” indicating the comparable group z as the comparison identification information.

In a case where there is no such comparison identification information, a user or the like needs to perform complicated work such as identifying which of the 18 3D objects in FIG. 4 can be compared, for example. As described above, the generation device 101 generates and signals the comparison identification information, so that the client device 103 can easily specify which 3D object can be compared with which 3D object on the basis of the comparison identification information.

It is noted that the comparison identification information can also be described in the MPD. For example, as illustrated in FIG. 4, comparison identification information corresponding to each scene description may be described in association with access information to each scene description.

<Comparison Display Information>

Further, the comparison information (Compare_data_ext1 to Compare_data_ext6) may include comparison display information that is information regarding display of a comparable 3D object. That is, the comparison display information is information regarding how to reproduce and display the 3D object when the 3D object is reproduced and displayed in a comparable manner.

<Others>

Note that the configuration of the distribution data is arbitrary and is not limited to the example of FIG. 4. For example, the numbers of 3D objects and scene descriptions are arbitrary. Further, the number of 3D objects corresponding to each scene description is also arbitrary. Further, since the comparison information is generated for each scene description, the number thereof is not limited to the example of FIG. 4. Of course, comparable 3D objects are also optional. That is, the comparable group included in the distribution data is not limited to the example of FIG. 4. Further, the value of compare id is also arbitrary, and is not limited to x, y, and 2 in FIG. 4.

<Comparable Display 1>

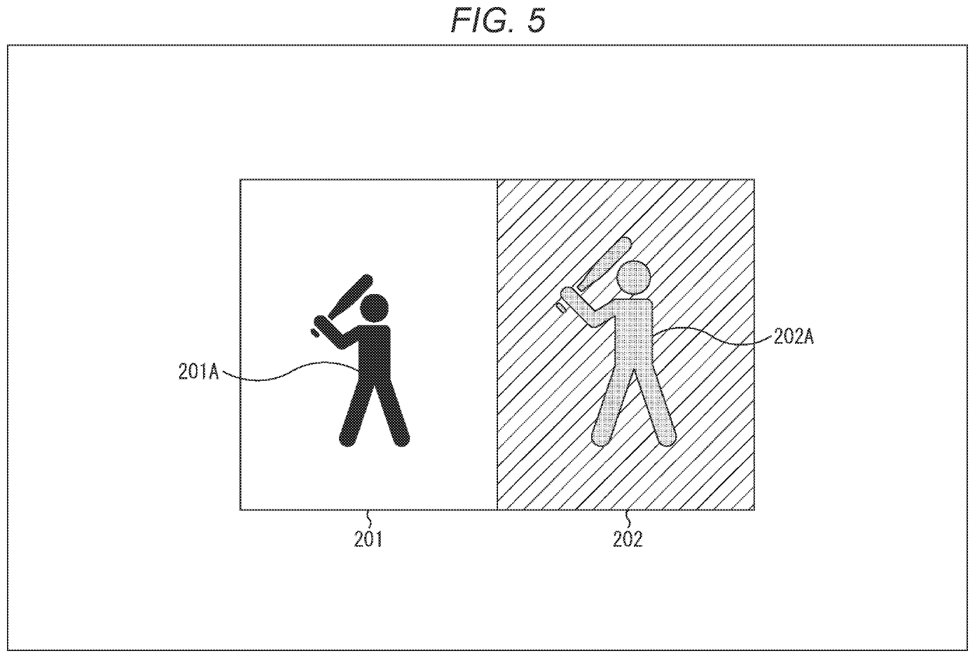

Next, a comparable display method of 3D objects will be described. A comparable display method of 3D objects is arbitrary. For example, as illustrated in FIG. 5, a plurality of 6DoF videos including a comparison target 3D object may be displayed side by side. That is, in this case, the comparison information includes information for performing such display.

In the case of the example of FIG. 5, a 6DoF video 201 including an object 201A, which is a comparison target 3D object, and a 6DoF video 202 including an object 202A, which is also a comparison target 3D object, are displayed side by side. With this display, for example, it is possible to compare the state of the swing of the bat by the object 201A with the state of the swing of the bat by the object 202A. That is, in order to be able to compare one 3D object arranged in a certain scene description (6DoF scene description) with a 3D object arranged in another scene description (6DoF scene description), the 6DoF videos are displayed side by side with the viewpoint position, the line-of-sight direction, the view angle, and the like appropriately aligned.

In order to compare and display 3D objects arranged in different 6DoF scene descriptions, comparison display information such as viewpoint position information indicating a viewpoint position in each 6DoF scene description, line-of-sight direction information indicating a line-of-sight direction at the viewpoint position, view angle information indicating a display area, information indicating how to arrange 6DoF videos at the time of display, start time information indicating a start time of a comparison target motion of the 3D object, end time information indicating the end time, and information indicating how to use the time information is required so that comparable 3D objects are viewed from the same angle to the same size.

<Signal Example of Comparison Information>

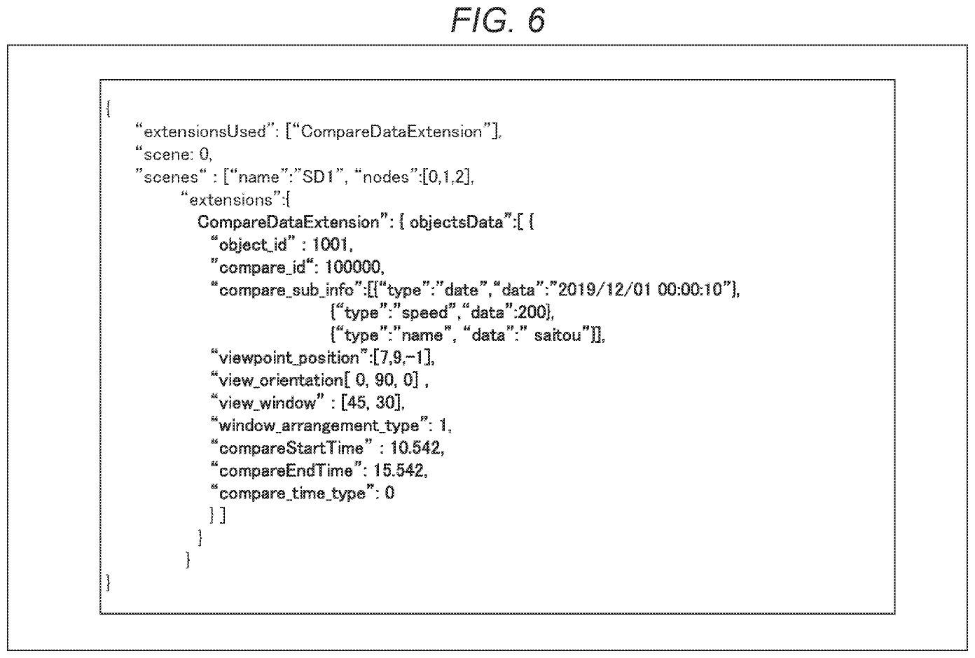

FIG. 6 illustrates an example of signaling of comparison information in a case where such display is performed. This example is described in glTF 2.0 (see Non-Patent Document 4), which is a format for arranging 3D still image content, animation data, and the like in a 6DoF space. The glTF 2.0 is expected to be adopted as a scene description of MPEG-I in view of its extensibility and a situation that various tools are already compatible with the glTF, and studies of standard extension in MPEG-I have started so that 3D moving image content, 3D Audio content, and the like can also be described.

In this example, an extension “CompareDataExtension” for signaling the comparison information is defined in a glTF object called “scene”, and in the extension, the comparison identification information and the comparison display information are signaled.

As the comparison identification information, in addition to the above-described “compare_id”, “compare_sub_info” and “object_id” are signaled.

“compare_sub_info” is information indicating a sub-category of “compare_id”. For example, as the “compare_sub_info”, arbitrary information regarding the comparison target such as date and time, player name, ball type (for example, straight, curve, fork, and the like), ball speed, and rotation speed can be signaled. A method of using this “compare_sub_info” information is arbitrary. For example, the information of “compare_sub_info” may be used for sorting or searching content. Further, for example, category information may be signaled in “compare_sub_info.type”, and an actual value in the category may be signaled in “compare_sub_info.data”.

The “object_id” is information indicating a comparison target 3D object. That is, the “object_id” is identification information indicating which 3D object is a comparison target among the 3D objects corresponding to the scene description. That is, this “object_id” is signaled in order to associate the scene description with the comparison target 3D object.

As the comparison display information, “viewpoint_position”, “view_orientation”, “view_window”, “window_arrangement_type”, “compareStartTime”, “compareEndTime”, and “compare_time_type” are signaled.

The “viewpoint_position” is information (also referred to as initial viewpoint position information, and for example, a three-dimensional array) indicating an initial viewpoint position at which the 3D object is viewed for comparison. “view_orientation” is information (also referred to as initial line-of-sight method information, and for example, a three-dimensional array) indicating an initial line-of-sight method at this initial viewpoint position for comparison. “view_window” is information (also referred to as view angle information, and for example, a two-dimensional array) indicating vertical and horizontal view angles at which the 6DoF video including the 3D object is cut out for comparison. “window_arrangement_type” is information (also referred to as arrangement method information) indicating an arrangement method (for example, whether to arrange horizontally or vertically, and the like) of the 6DoF video at the time of comparison display. “compareStartTime” is information indicating a time (also referred to as a comparison start time, and for example, the elapsed time from the content head, and the like) at which the comparison is started. “compareEndTime” is information indicating a time (also referred to as a comparison end time, and for example, the elapsed time from the content head, and the like) at which the comparison is ended. “compare_time_type” is information related to the reproduction speed of each comparison target content.

For example, in a case where the time lengths (also referred to as comparison target time lengths) of the contents are different between the comparison targets, a method of performing fast-forward reproduction (that is, reproduction at a reproduction speed higher than a normal speed) or slow-reproduction (that is, reproduction at a reproduction speed lower than the normal speed) of the contents so as to match the comparison end times of the comparison targets is considered. Further, it is also conceivable to reproduce both at a normal speed without matching the comparison end times. “compare_time_type” is information (that is, information indicating at what type of reproduction speed the content is reproduced) indicating such a type of reproduction speed.

Of these signals, “window_arrangement_type” and “compare_time_type” should be the same information for those to be subject to the same comparison, so they are signaled to have the same value for those of the same “compare_id”.

The “CompareDataExtension” as described above is assumed to include a plurality of comparable 3D objects in one 6DoF video, and is an array having comparison information for each 3D object. That is, the comparison information may be configured for each 3D object.

Further, the “CompareDataExtension” as described above can be signaled, for example, in a scene description. That is, the comparison information can be included in the scene description.

<MPD>

In a case where it is assumed that DASH distribution is performed, the comparison identification information may be signaled in the MPD. That is, the comparison identification information can be included in the MPD. In this way, the client device 103 can know which data can be compared before acquiring the 6DoF scene description including the comparison information. Therefore, for example, the client device 103 can create list information of comparison targets from the comparison identification information of the MPD and present the list information to the user as a user interface (UI).

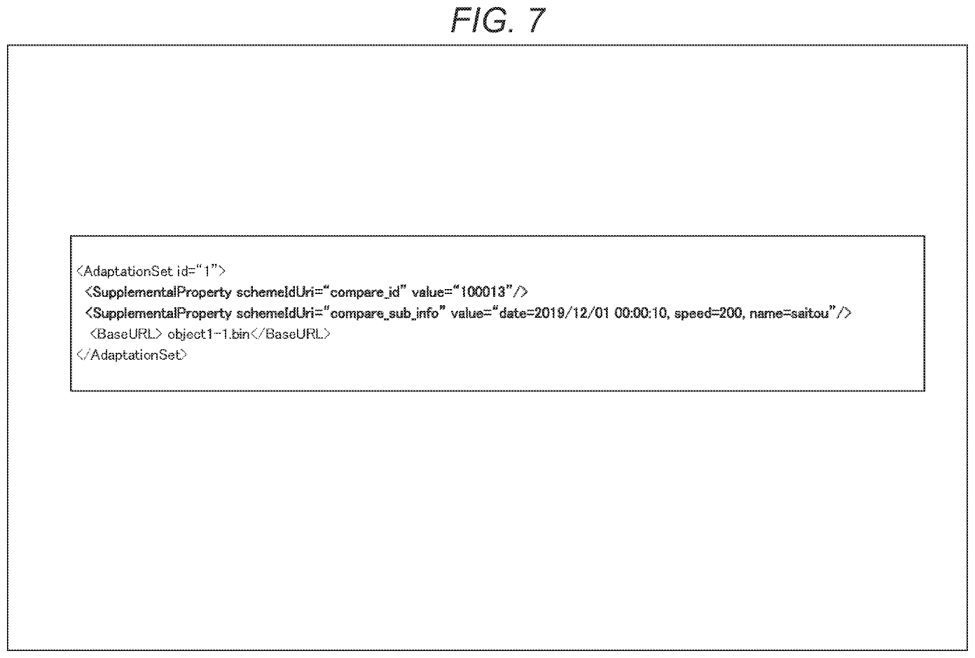

FIG. 7 is a diagram illustrating an example of the MPD in that case. In the case of the example of FIG. 7, “compare_id” and “compare_sub_info” which are the comparison identification information are signaled in the supplemental property of the AdaptationSet including the comparison target 3D object. Of course, the position to signal the comparison identification information is arbitrary and is not limited to the example of FIG. 7.

<Flow of File Generation Process>

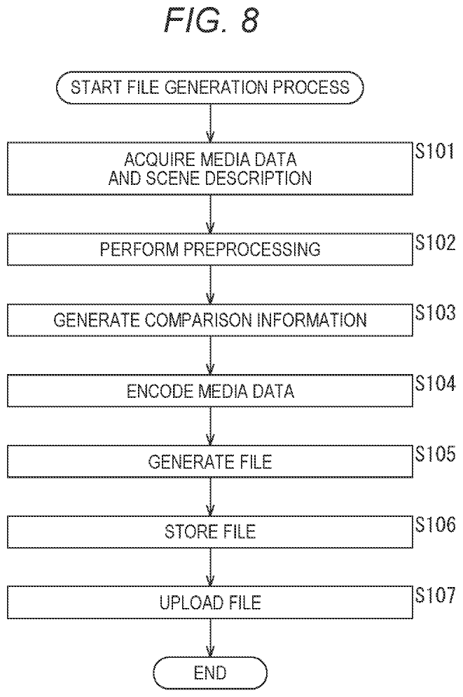

The generation device 101 can generate and signal such comparison information by executing a file generation process. An example of a flow of the file generation process in this case will be described with reference to the flowchart of FIG. 8.

When the file generation process is started, in step S101, the data input unit 121 of the generation device 101 acquires the media data and the scene description of the 6DoF content to be distributed.

In step S102, the preprocessing unit 122 appropriately performs preprocessing on the media data and the scene description.

In step S103, the comparison information generation unit 124 generates the comparison information on the basis of the media data, the scene description, the setting by the user, and the like. At that time, the comparison information generation unit 124 generates comparison information for each scene description.

In step S104, the encoding unit 123 encodes the media data and generates the encoded data thereof.

In step S105, the file generation unit 125 generates a file including the comparison information generated in step S103, the scene description, the encoded data of the media data in step S104, and the like.

In step S106, the storage unit 127 stores the file generated in step S105.

In step S107, the upload unit 128 reads the file stored in the storage unit 127 at a predetermined timing or in response to a predetermined event, request, or the like, and uploads the file to the server 102.

When the file upload is completed, the file generation process ends.

By performing the file generation process as described above, generation device 101 can signal the comparison information. As a result, the client device 103 can grasp comparable content on the basis of the comparison information. Moreover, the client device 103 can display the comparison target 3D object on the basis of the comparison information so that the user can easily compare the 3D object. Therefore, the user of the client device 103 can more easily compare the 3D objects. For example, the user can more easily compare the movements of the comparison target 3D objects from all viewpoints.

<Flow of Reproduction Process>

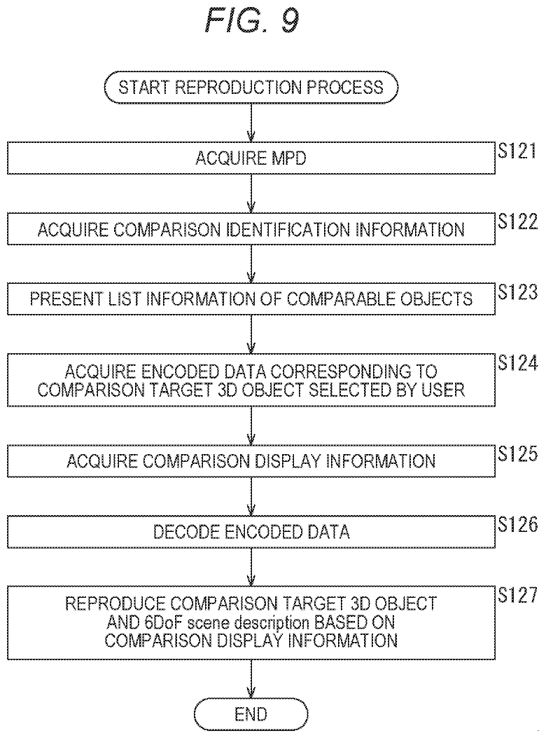

By executing the reproduction process, the client device 103 can reproduce and display a plurality of 3D objects of 6DoF content in a comparable manner. An example of the flow of the reproduction process in this case will be described with reference to the flowchart of FIG. 9.

When the reproduction process is started, in step S121, the MPD processing unit 161 of the client device 103 accesses the server 102 and acquires the MPD of the desired 6DoF content. The MPD processing unit 161 parses the acquired MPD.

In step S122, the comparison information acquisition unit 163 acquires the comparison identification information signaled in the MPD on the basis of the parsing result.

In step S123, the display unit 169 presents list information of comparable 3D objects to the user on the basis of the comparison identification information. For example, the display control unit 164 specifies 3D objects belonging to the same comparable group on the basis of “compare_id”, generates display control information for displaying a list of the 3D objects, and supplies the display control information to the buffer 167. The display information generation unit 168 acquires the display control information via the buffer 167, and generates display information including a list of comparable 3D objects. The display unit 169 presents a list of comparable 3D objects to the user by displaying the display information on the monitor.

The user enters a selection of 3D objects to compare on the basis of the presented list of comparable 3D objects. An input unit (not illustrated) of the client device 103 receives an input operation by the user or the like. That is, selection input of comparison target 3D objects by the user or the like is received.

In step S124, the encoded data acquisition unit 165 acquires the encoded data corresponding to the comparison target 3D object selected by the user, that is, the encoded data of the media data of the 3D object.

In step S125, the comparison information acquisition unit 163 acquires comparison display information corresponding to the comparison target 3D object. For example, the comparison information acquisition unit 163 acquires the comparison display information corresponding to the comparison target 3D object selected by the user on the basis of “compare_sub_info”, “object_id”, or the like. For example, in a case where the comparison display information is signaled in the scene description, the comparison information acquisition unit 163 acquires the scene description including the comparison display information corresponding to the comparison target 3D object selected by the user, and acquires the comparison display information from the scene description.

In step S126, the decoding unit 166 decodes the encoded data acquired in step S124, and generates (restores) the media data of the comparison target 3D object.

In step S127, the display information generation unit 168 or the like reproduces and displays the comparison target 3D object and the scene description (6DoF scene description) on the basis of the comparison display information or the like acquired in step S125. For example, the display control unit 164 reproduces and displays the comparison target 3D object and the scene description (6DoF scene description) in a comparable manner on the basis of the comparison display information or the like.

In that case, for example, the display control unit 164 can specify the initial viewpoint position from “viewpoint_position”. Further, the display control unit 164 can specify the initial line-of-sight direction from “view_orientation”. Further, the display control unit 164 can specify vertical and horizontal view angles at which the 6DoF video is cut out from the “view_window”. That is, the display control unit 164 can set each 6DoF video to be compared on the basis of these pieces of information.

Further, the display control unit 164 can specify the arrangement method of the 6DoF video from “window_arrangement_type”. Further, the display control unit 164 can specify the comparison start time from “compareStartTime”, specify the comparison end time from “compareEndTime”, and specify the reproduction speed from “compare_time_type”. That is, the display control unit 164 can set how to display each 6DoF video to be compared on the basis of these pieces of information.

Then, the display information generation unit 168 generates display information as illustrated in FIG. 5, for example, according to the display control, and the display unit 169 displays the display information on the monitor. By doing so, a plurality of 3D objects is reproduced and displayed in a comparable manner.

When the process of step S127 ends, the reproduction process ends.

By performing the reproduction process as described above, the client device 103 can grasp the comparable content on the basis of the signaled comparison information. Moreover, the client device 103 can reproduce and display a plurality of 3D objects in a comparable manner on the basis of the comparison information. At that time, the client device 103 can display the comparison target 3D object on the basis of the comparison information so that the user can easily compare the 3D object. Therefore, the user of the client device 103 can more easily compare the 3D objects. For example, the user can more easily compare the movements of the comparison target 3D objects from all viewpoints.

<Others>

FIG. 6 is an example of the scene description, and the description of the scene description is not limited to the example of FIG. 6. For example, extension for signaling similar information may be performed with a scene description (for example, a scene description described in Non-Patent Document 1) other than the glTF 2.0.

Further, the number of 6DoF videos including the comparison target 3D object is not limited to two, and two or more 6DoF videos can be compared with similar signals. In the comparison of more than two 6DoF videos, it is also conceivable to change and display the “view_window” indicating the display area. In that case, using “view_window” as arrangement information, the view angle information in the case of comparing three 6DoF videos, the view angle information in the case of comparing four 6DoF videos, and the like may be signaled. The same applies to the following Examples.

<Comparable Display 2>

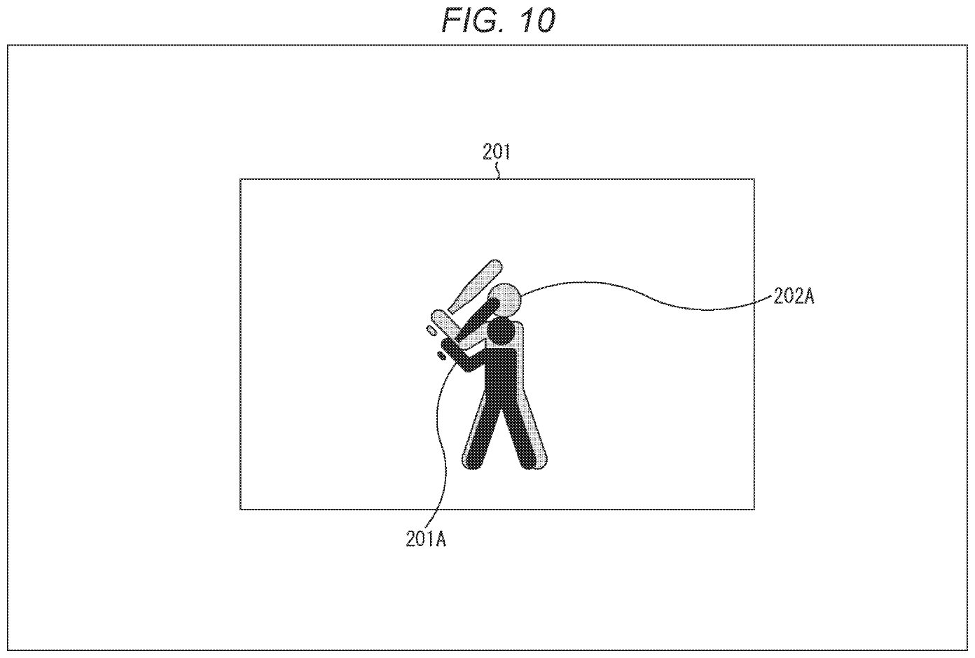

Note that a comparable display method of the 3D object is arbitrary, and is not limited to the example of FIG. 5. For example, both a scene description (6DoF scene description) and a 3D object may be used in one of the 6DoF contents to be compared, only a 3D object may be used in the other 6DoF content, and the 3D object and the other 3D object may be superimposed and displayed in one scene description. That is, for example, as illustrated in FIG. 10, another 3D object may be superimposed and displayed on the 6DoF content corresponding to one of the plurality of comparison target 3D objects so that the 3D objects are superimposed and displayed. That is, in this case, the comparison information includes information for performing such display.

In the example of FIG. 10, an object 201A is arranged and displayed so as to be superimposed on a 6DoF video 201 including the object 202A in a state suitable for comparison with the object 201A. That is, the other 3D object is superimposed on one 3D object and the background. With this display, for example, it is possible to superimpose and compare the state of the swing of the bat by the object 201A and the state of the swing of the bat by the object 202A.

In order to realize such display, comparison display information such as viewpoint position information in each 6DoF scene description, position information (information used as information for obtaining information indicating a line-of-sight direction and superimposing 3D objects) for indicating the center position of the 3D object, priority information indicating which scene description is used as a base at the time of display (which scene description is applied), view angle information indicating a display area, start time information and end time information of a comparison target motion of the 3D object, and information indicating how to use the time information is required so that the comparable 3D objects are arranged so as to be able to be compared with each other.

<Signal Example of Comparison Information>

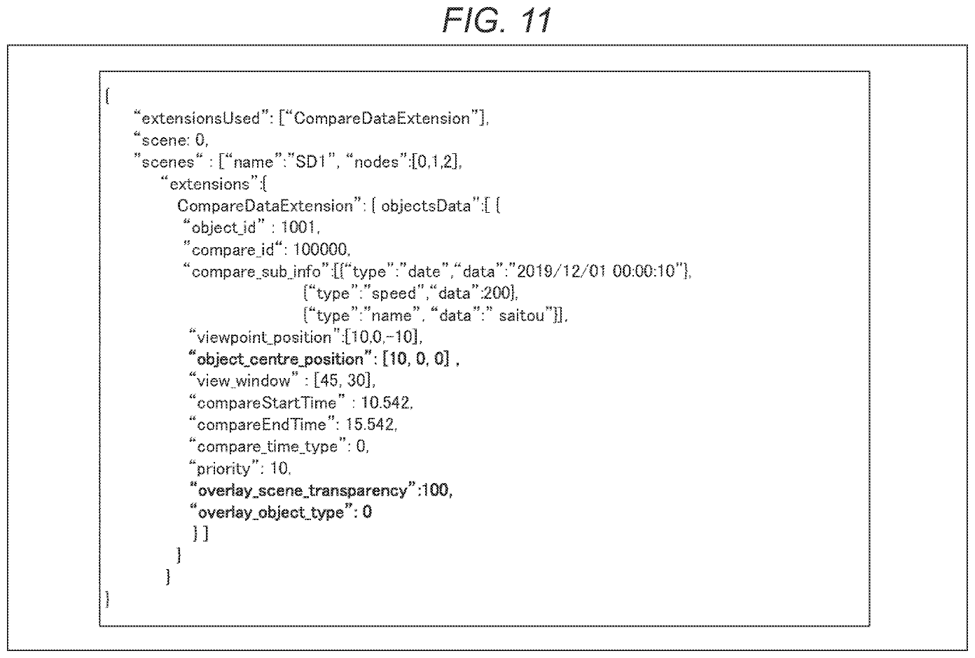

FIG. 11 illustrates an example of signaling of comparison information in a case where such display is performed. This example is also described in glTF 2.0 as in FIG. 6. Description of parts similar to those in the example of FIG. 6 will be omitted. In this example, “object_centre_position”, “priority”, “overlay_scene_transparency”, and “overlay_object_type” are signaled as the comparison display information.

“object_centre_position” is information (for example, a three-dimensional array) indicating a center point (center point of a bounding box that is a cube storing a 3D object) of the 3D object. This information can be used not only to superimpose two 3D objects, but also to derive the line-of-sight direction. That is, this information includes line-of-sight direction information.

“priority” is information related to the priority. For example, this information may indicate content (that is, content that uses not only the 3D object but also the scene description) serving as a base for superimposition. That is, the client device 103 may determine which content is to be the base on the basis of the priority indicated in “priority”.

Note that the “priority” may directly or indirectly indicate the priority. For example, “priority” may indicate what is used as the priority. For example, it is also conceivable to use date and time information when the content is created and use the old content as a base. In that case, for example, “priority” may signal that the content is based on the content of which the date and time information when the content is created is the oldest, and “compare_sub_info” may signal the date and time information when the content is created. By doing so, for example, the client device 103 can grasp that the content of which the date and time information when the content is created is the oldest is to be the base, on the basis of the “priority”, and can select the content to be the base, on the basis of the date and time information signaled as the “compare_sub_info”.

“overlay_scene_transparency” signals the transparency of the 6DoF video including the superimposed 3D object. By setting this transparency to 100%, only the 3D object can be superimposed without superimposing the scene description. It is noted that the transparency may be less than 100%. That is, the plurality of 3D objects and the background may be superimposed. That is, the other scene description (including the comparison target 3D object) may be superimposed and displayed on one scene description (including the comparison target 3D object) to be the base. For example, in the case of FIG. 10, the object 202A is superimposed on the 6DoF video 201, but the 6DoF video 201 may be superimposed on the 6DoF video 202 at a predetermined transparency. In this way, it is possible to superimpose the backgrounds of the plurality of 6DoF videos.

“overlay_object_type” signals how to display the 3D object to be superimposed. For example, this “overlay_object_type” specifies a display method such as a skeleton, difference information, a bone, or a line. For example, a display method such as making the transparency of the 3D object to be superimposed greater than 0%, setting the pixel value of the portion to be superimposed as a difference value between both the 3D objects, displaying the 3D object to be superimposed as a line, or displaying only the outer shape (outer frame) of the 3D object to be superimposed can be specified by this information.

In the example of FIG. 10, “compare_time_type”, “overlay_scene_transparency”, and “overlay_object_type” should be the same information for those to be subject to the same comparison, so they are signaled to have the same value for those of the same “compare_id”. Further, in a case where “priority” indicates the comparison priority by type, this “priority” is similarly signaled to have the same value for the same “compare_id”.

These pieces of comparison display information are used, for example, in the reproduction process executed by the client device 103. For example, in step S127 of the reproduction process (FIG. 9), the display control unit 164 can specify the center point of each comparison target 3D object from the “object_centre_position”. Therefore, the display control unit 164 can superimpose the respective 3D objects by arranging the respective 3D objects so as to align the center points (at the same position). Note that the display control unit 164 can also specify the initial line-of-sight direction from this “object_centre_position”.

Further, the display control unit 164 can determine which content is to be used as a base on the basis of the “priority”. That is, the display control unit 164 can designate the base 6DoF video on the basis of “priority”.

Further, the display control unit 164 can specify the transparency of the 6DoF video including the superimposed 3D object from the “overlay_scene_transparency”. That is, the display control unit 164 can set the transparency of the 6DoF video including the superimposed 3D object to the transparency designated by “overlay_scene_transparency”.

Further, the display control unit 164 can specify a display method of the 3D object to be superimposed from the “overlay object type”. That is, the display control unit 164 can set the display method of the 3D objects to be superimposed to the type designated by “overlay_object_type”.

Then, the display information generation unit 168 generates the display information as illustrated in FIG. 10, for example, according to the display control as described above, and the display unit 169 displays the display information on the monitor. By doing so, a plurality of 3D objects is reproduced and displayed in a comparable manner.

Also in this case, the “CompareDataExtension” can be signaled in the scene description, for example. That is, the comparison information can be included in the scene description.

### Comparison Example

In such a 6DoF video displayed in a comparable manner, it is desirable that the comparison target 3D objects remain at substantially the same position and move. For example, in a case where the 3D object performing swimming or short distance running, for example, moves in the 6DoF scene description, the viewpoint position, the line-of-sight direction, and the like are only required to be changed in accordance with the movement such that the comparison target 3D object remains at substantially the same position in the 6DoF video.

The signal described above indicates an initial value of information for comparison. By matching the initial values, the comparison display can be similarly performed even in a case where the position of the 3D object changes with the lapse of time.

For example, in the “compare_time_type”, a comparison method other than the comparison of movements, such as comparing the speed difference, can be realized by designating the reproduction without matching the comparison end time.

<Comparable Display 3>

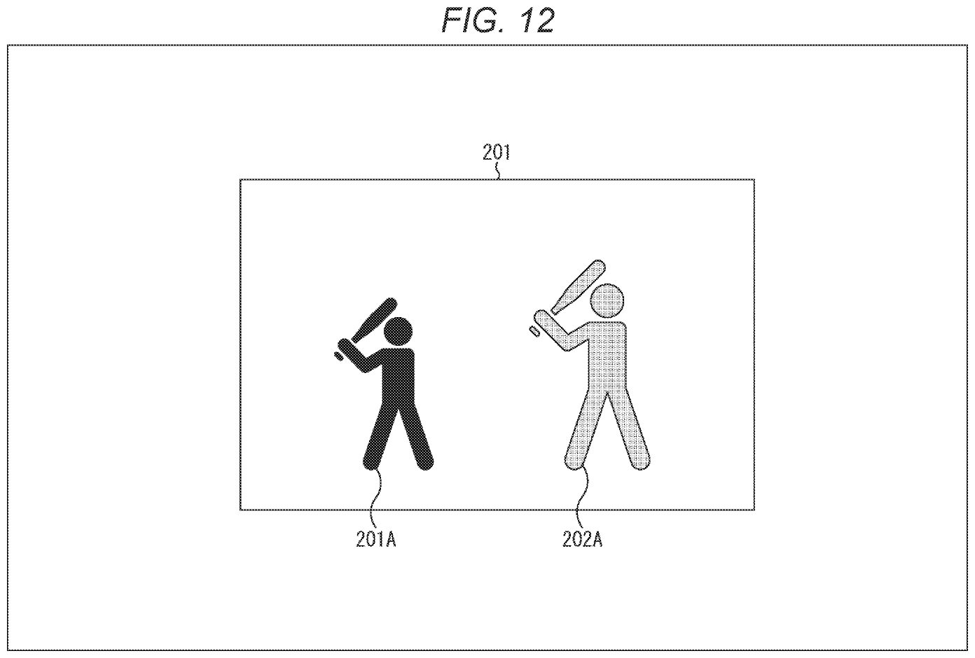

For example, both a scene description (6DoF scene description) and a 3D object may be used in one of the 6DoF contents to be compared, only a 3D object may be used in the other 6DoF content, and the 3D object and the other 3D object may be superimposed and displayed in one scene description. That is, for example, as illustrated in FIG. 12, another 3D object may be superimposed and displayed on the 6DoF content corresponding to one of the plurality of comparison target 3D objects so that the 3D objects are superimposed and displayed. That is, in this case, the comparison information includes information for performing such display.

In the example of FIG. 12, an object 201A is arranged on a 6DoF video 201 including the object 202A so as to be displayed side by side in a state suitable for comparison with the object 201A. That is, the other 3D object is superimposed on one 3D object and the background. With this display, for example, in the 6DoF video 201, it is possible to compare the state of the swing of the bat by the object 201A and the state of the swing of the bat by the object 202A side by side.

In order to realize such display, comparison display information such as viewpoint position information in each 6DoF scene description, position information (Information used as information for obtaining information indicating a line-of-sight direction and further superimposing a 3D object) for indicating the center position of the 3D object, priority information indicating which is used as a base when displaying (which scene description is applied), view angle information indicating a display area, position information indicating where to arrange the 3D object to be superimposed, start time information and end time information of the comparison target motion of the 3D object, and information indicating how to use the time information is required so that the comparable 3D objects are arranged so as to be able to be compared with each other.

<Signal Example of Comparison Information>

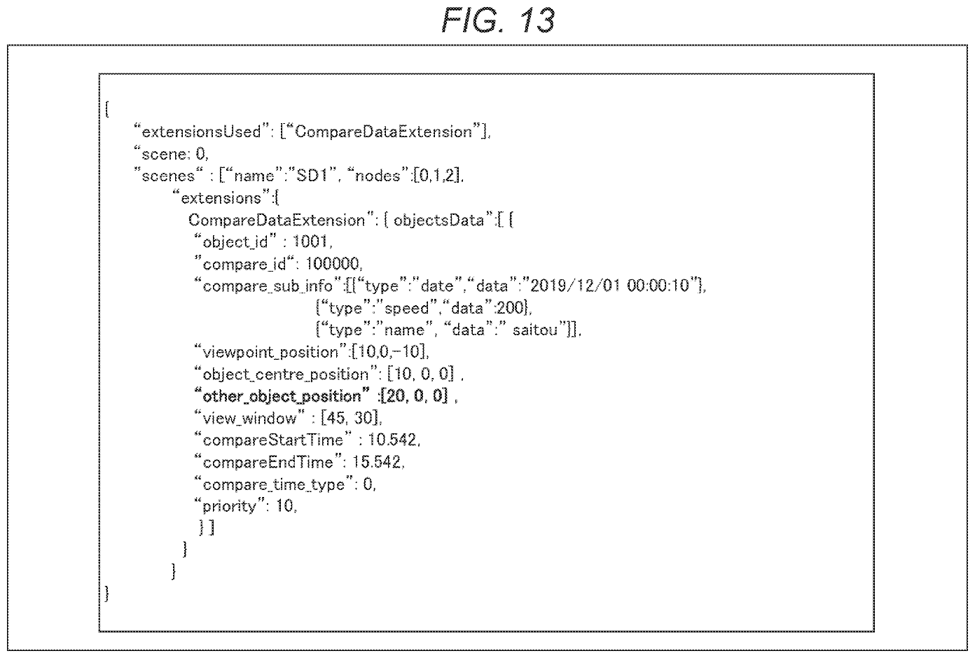

FIG. 13 illustrates an example of signaling of comparison information in a case where such display is performed. This example is also described in glTF 2.0 similarly to the examples of FIGS. 6 and 10. Description of parts similar to those in the examples of FIGS. 6 and 10 will be omitted. In this example, “other_object_position” is signaled as the comparison display information.

The “other_object_position” is position information indicating an arrangement location of the center point of the 3D object to be superimposed. This position information is only required to be signaled as an array corresponding to the number of 3D objects to be arranged. That is, in the case of comparing N 3D objects, (N−1) pieces of position information is only required to be signaled as a sequence. For example, in the case of FIG. 12, since it is a comparison of two 3D objects, one piece of position information is signaled.

Note that, in the example of FIG. 13, since “compare_time_type” should be the same information for those to be subject to the same comparison, so it is signaled to have the same value for those of the same “compare_id”. Further, in a case where “priority” indicates the comparison priority by type, this “priority” is similarly signaled to have the same value for the same “compare_id”.

These pieces of comparison display information are used, for example, in the reproduction process executed by the client device 103. For example, in step S127 of the reproduction process (FIG. 9), the display control unit 164 can specify the arrangement location of the center point of the 3D object to be superimposed from the “other_object_position”. Therefore, the display control unit 164 can set the position of the center point of each 3D object to such a position that the 3D objects do not overlap each other on the basis of this information.

Then, the display information generation unit 168 generates the display information as illustrated in FIG. 12, for example, according to the display control as described above, and the display unit 169 displays the display information on the monitor. By doing so, a plurality of 3D objects is reproduced and displayed in a comparable manner.

Also in this case, the “CompareDataExtension” can be signaled in the scene description, for example. That is, the comparison information can be included in the scene description.

In the case of this example, in order to move the viewpoint position for comparison and realize viewing of the 3D object from the surroundings, the client device 103 needs to provide display such that one 6DoF video is viewed from two different viewpoints when displayed. In a case where such processing is not performed, since two 3D objects are arranged in one 6DoF video, there is a possibility that the 3D object is hidden behind the other and cannot be seen depending on the angle, or the sizes of the two 3D objects are displayed differently due to perspective. By appropriately adjusting the viewpoint position, the viewpoint direction, and the like as described above on the basis of the comparison display information and the like, the occurrence of such a phenomenon can be suppressed, and the user can more easily compare the 3D objects.

### 4. Second Embodiment

<Signaling of Comparison Information Corresponding to Plurality of Scene Descriptions>

In the present embodiment, a method for signaling comparison information corresponding to a plurality of scene descriptions will be described.

Also in this case, the configurations of the distribution system 100 and each device (for example, the generation device 101 and the client device 103) constituting the distribution system 100 are similar to those in the case of the first embodiment described above. That is, unless otherwise specified, the description of the distribution system 100 and the configuration of each device performed in the first embodiment can also be applied to the second embodiment.

<Distribution Data>

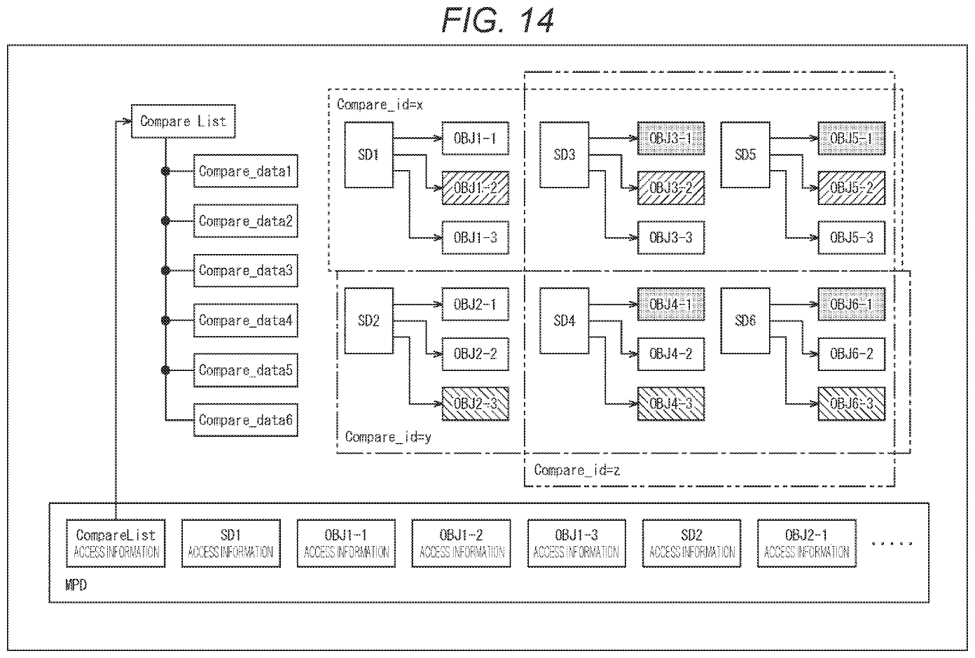

Next, data of 6DoF content in this case will be described. In this case, the generation device 101 generates, for example, data as illustrated in FIG. 14 as the data of the 6DoF content. FIG. 14 is a diagram illustrating an example of distribution data distributed as 6DoF content.

In the case of the example of FIG. 14, the comparison information (comparison identification information and comparison display information) which has been distributed and signaled for each scene description in the example of FIG. 4 is listed and put together into one, and arranged at the same level as each scene description. That is, a Compare List that is a list of comparison information is generated, and is signaled separately from the scene descriptions (SD1 to SD6). That is, the Compare List includes comparison information (Compare_data1 to Compare_data6) corresponding to each scene description. With such a Compare List, access to the comparison information becomes easier. Note that, in a case where an MPD is generated, the MPD may include information (CompareList access information) for accessing the Compare List. This access information makes it easier to access the comparison information.

<Comparison Control Information>

The comparison information (Compare List) may include comparison control information that is information for listing the comparison information regarding a plurality of 3D objects.

<Signal Example of Comparison Information>

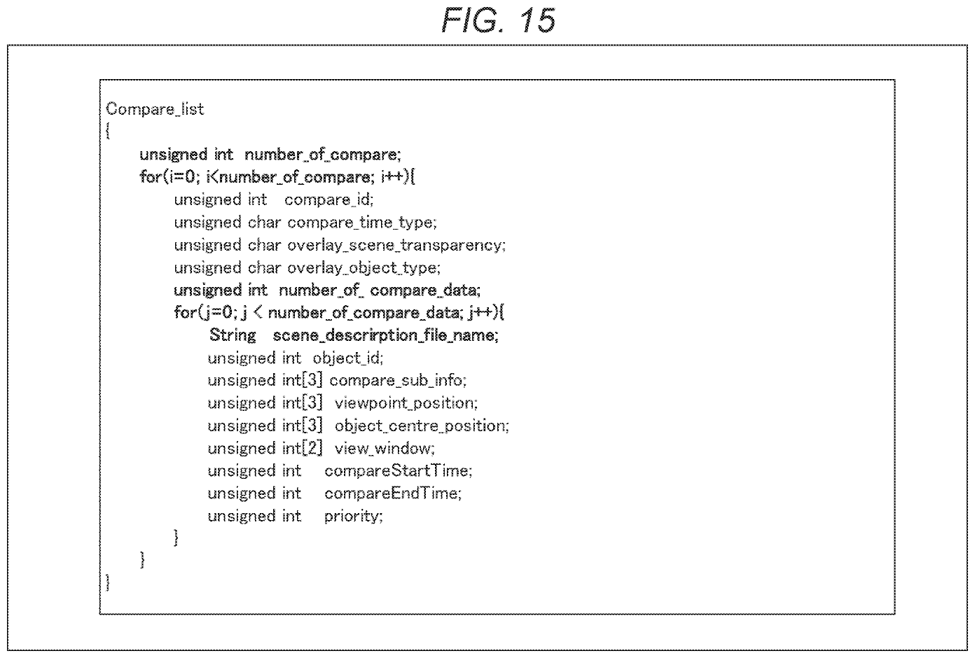

FIG. 15 illustrates an example of signaling of comparison information in a case where such display is performed. This example is described by binary data. Description of parts similar to the parameters described in the first embodiment will be omitted.

For example, the comparison information (Compare List) may include “number_of_compare”, “number_of_compare_data”, “Scene_description_file_name”, and the like as the comparison control information.

The “number_of_compare” is information indicating the number of “compare_id” to be signaled. Further, the “number_of_compare_data” is information indicating the number of comparison target 3D objects grouped by the “compare_id”. Further, the “Scene_description_file_name” is information indicating a 6DoF video associated with each 3D object. For example, in order to collect the comparison information for each “compare_id”, the number of “compare_id” is signaled by “number_of_compare”. Further, the number of comparison target 3D objects grouped by this “compare_id” is signaled by “number_of_compare_data”, and each piece of comparison information is signaled by the number of pieces of “number_of_compare_data”. At this time, “Scene_description_file_name” is signaled as the information of the 6DoF video associated with each 3D object.

Note that “compare_time_type”, “overlay_scene_transparency”, and “overlay_object_type” should be the same information for those to be subject to the same comparison, so they are signaled together with “compare_id” so as to have the same value for those of the same “compare_id”.

<MPD>

In a case where it is assumed that DASH distribution is performed, access information to the comparison information (Compare List) may be signaled in the MPD. In this way, the client device 103 can acquire the compare_list at the beginning of the processing. That is, the comparison information (Compare List) can be easily acquired. Then, the client device 103 can create list information of comparison targets on the basis of the comparison information (Compare List) and present the list information to the user as a user interface (UI).

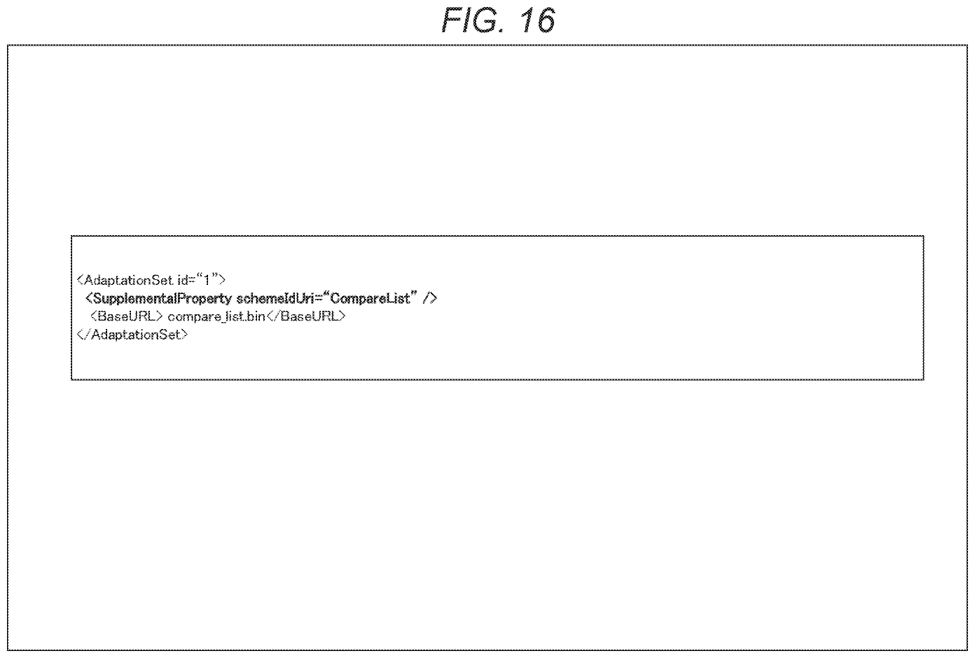

FIG. 16 is a diagram illustrating an example of the MPD in that case. In the case of the example of FIG. 16, information indicating that the comparison information is listed (that is, Compare List) is signaled in the supplemental property of the AdaptationSet including the Compare List of the MPD. Of course, the position for signaling the information indicating that it is the Compare List is arbitrary and is not limited to the example of FIG. 16.

<Flow of File Generation Process>

The flow of the file generation process in this case is basically similar to the example of FIG. 8. However, in step S103, the comparison information generation unit 124 generates comparison information (Compare List) obtained by listing and collecting the comparison information corresponding to each of the plurality of scene descriptions, that is, comparison information corresponding to the plurality of scene descriptions. The other processing is performed similarly to the case of FIG. 8.

<Flow of Reproduction Process>

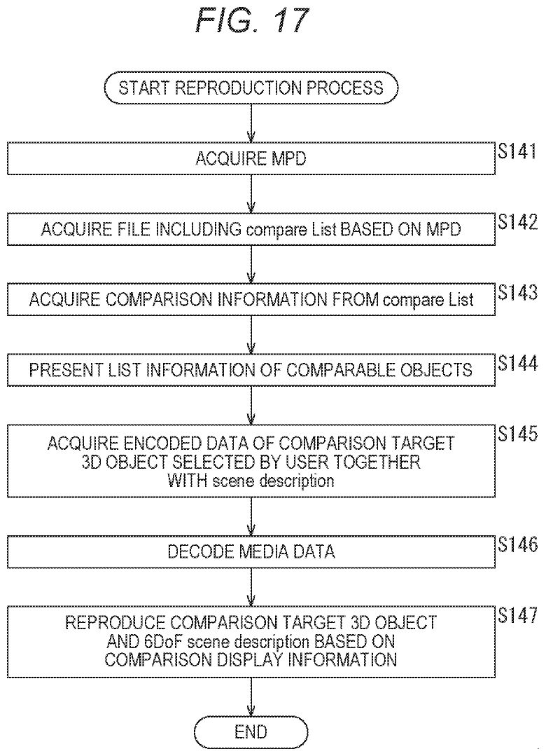

Next, an example of a flow of the reproduction process in this case will be described with reference to the flowchart of FIG. 17.

When the reproduction process is started, in step S141, the MPD processing unit 161 of the client device 103 accesses the server 102 and acquires the MPD of the desired 6DoF content. The MPD processing unit 161 parses the acquired MPD.

In step S142, the comparison information acquisition unit 163 acquires a file including a compare List signaled in the MPD on the basis of the parsing result. That is, the comparison information acquisition unit 163 acquires a compare List indicated in the MPD.

In step S143, the comparison information acquisition unit 163 acquires comparison identification information from the compare List acquired in step S142.

In step S144, the display unit 169 presents list information of comparable 3D objects to the user on the basis of the comparison identification information. For example, the display control unit 164 specifies 3D objects belonging to the same comparable group on the basis of “compare_id”, generates display control information for displaying a list of the 3D objects, and supplies the display control information to the buffer 167. The display information generation unit 168 acquires the display control information via the buffer 167, and generates display information including a list of comparable 3D objects. The display unit 169 presents a list of comparable 3D objects to the user by displaying the display information on the monitor.

The user enters a selection of 3D objects to compare on the basis of the presented list of comparable 3D objects. An input unit (not illustrated) of the client device 103 receives an input operation by the user or the like. That is, selection input of comparison target 3D objects by the user or the like is received.

In step S145, the encoded data acquisition unit 165 acquires the encoded data corresponding to the comparison target 3D object selected by the user, that is, the encoded data of the media data of the 3D object. Further, the comparison information acquisition unit 163 acquires a scene description corresponding to the 3D object. The comparison information acquisition unit 163 acquires comparison display information corresponding to the comparison target 3D object. For example, the comparison information acquisition unit 163 acquires the comparison display information corresponding to the comparison target 3D object selected by the user on the basis of “compare_sub_info”, “object_id”, or the like.

In step S146, the decoding unit 166 decodes the encoded data acquired in step S145, and generates (restores) the media data of the comparison target 3D object.

In step S147, the display information generation unit 168 or the like reproduces and displays the comparison target 3D object and the scene description (6DoF scene description) on the basis of the comparison display information or the like acquired in step S145. For example, the display control unit 164 reproduces and displays the comparison target 3D object and the scene description (6DoF scene description) in a comparable manner on the basis of the comparison display information or the like. As described in the first embodiment, the display control unit 164 controls the display on the basis of each parameter of the comparison display information. The display information generation unit 168 generates display information capable of comparing a plurality of 3D objects according to the display control, and the display unit 169 displays the display information on the monitor. By doing so, a plurality of 3D objects is reproduced and displayed in a comparable manner.

When the process of step S147 ends, the reproduction process ends.

By performing the reproduction process as described above, the client device 103 can more easily reproduce and display the plurality of 3D objects in a comparable manner on the basis of the signaled comparison information. Therefore, the user can more easily compare the 3D objects.

<Others>

For example, as the “compare_sub_info”, the number of times of distribution (display), the number of times of liking, or the like may be signaled. For example, the information may be updated each time the information is updated, and the sort display or the like may be realized in order of popular content. In a case where the pieces of comparison information corresponding to the respective scene descriptions are grouped into one as described above, such update of the comparison information can be more easily realized as compared with a case where the comparison information is distributed for each scene description as in the case of the first embodiment.

Further, “priority” may indicate that the number of times of display (the number of times of distribution) or the like is used as the priority.

<Distribution Data>

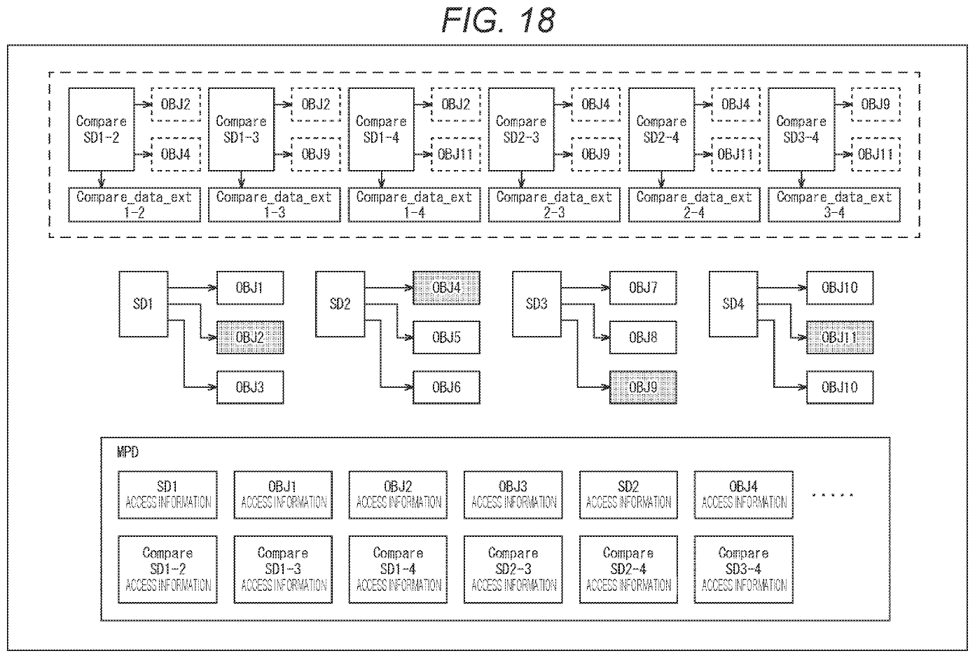

Further, for example, as illustrated in FIG. 18, a new scene description for comparison including comparison information may be created for a combination of comparisons. In the example of FIG. 18, it is assumed that 3D objects OBJ2, OBJ4, OBJ9, and OBJ11 illustrated in gray are 3D objects that can be compared with each other. In this case, there are six combinations of comparison. Therefore, the scene descriptions for comparison include a scene description (CompareSD1-2) for comparison between the 3D objects OBJ2 and OBJ4, a scene description (CompareSD1-3) for comparison between the 3D objects OBJ2 and OBJ9, a scene description (CompareSD1-4) for comparison between the 3D objects OBJ2 and OBJ11, a scene description (CompareSD2-3) for comparison between the 3D objects OBJ4 and OBJ9, a scene description (CompareSD2-4) for comparison between the 3D objects OBJ4 and OBJ11, and a scene description (CompareSD3-1) for comparison between the 3D objects OBJ9 and OBJ11.

Further, as the comparison information, comparison information (Compare_data_ext1-2) corresponding to the scene description for comparison (CompareSD1-2), comparison information (Compare_data_ext1-3) corresponding to the scene description for comparison (CompareSD1-3), comparison information (Compare_data_ext1-4) corresponding to the scene description for comparison (CompareSD1-4), comparison information (Compare_data_ext1-5) corresponding to the scene description for comparison (CompareSD1-5), comparison information (Compare_data_ext2-3) corresponding to the scene description for comparison (CompareSD2-3), comparison information (Compare_data_ext2-4) corresponding to the scene description for comparison (CompareSD2-4), and comparison information (Compare_data_ext3-4) corresponding to the scene description for comparison (CompareSD3-4) is included.

Further, in the case of the example of FIG. 18, the distribution data includes the MPD corresponding to these pieces of data. That is, the MPD includes information for accessing the scene description for comparison.

<Signal Example of Comparison Information>

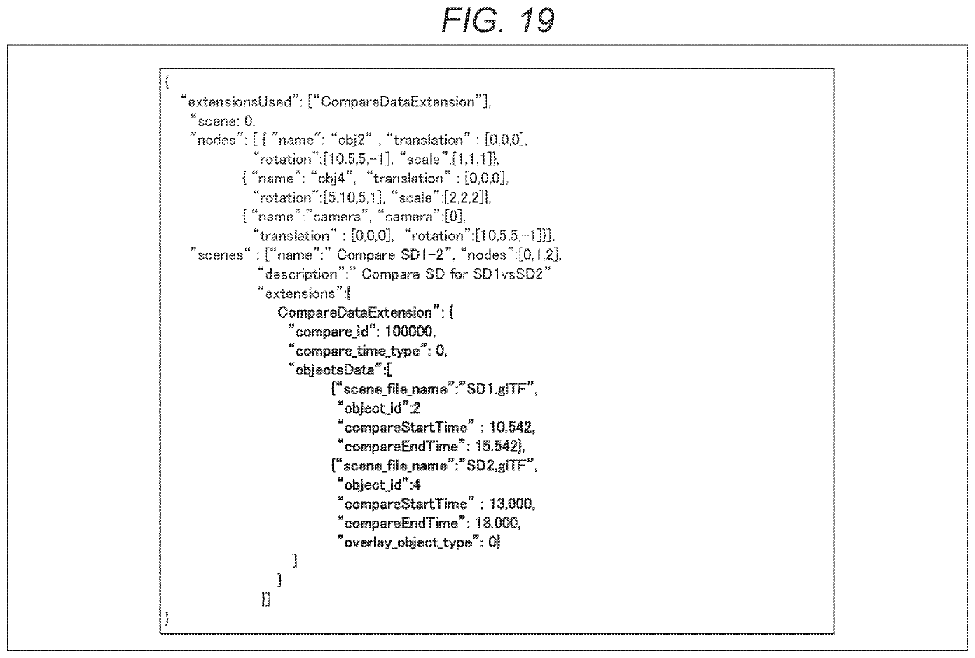

FIG. 19 illustrates an example of signaling of comparison information in a case where such display is performed. This example is also described in glTF 2.0 as in FIG. 6. The description of parts similar to those in the examples described above with reference to FIG. 6 and the like is omitted. This example is an example of signals when realizing a case where two 3D objects are compared side by side with one background as in the example of FIG. 12.

The “scene” described in the scene description for comparison has three “nodes”. Two of the “nodes” are information for arranging the 3D object in association with the “scene”, and have “translation”, “rotation”, “scale”, and the like as the arrangement information. These pieces of arrangement information are signaled such that the arrangement is suitable for comparison. The remaining one “node” is “camera” and has information corresponding to viewpoint position information and view angle information. Up to this point, the functions of the existing glTF 2.0 have been used.

The remaining comparison information is signaled by defining “CompareDataExtension” in “scene” using the extension function of glTF 2.0. Here, “compare_id” which is the comparison identification information and “compare_time_type” indicating a temporal reproduction method of the two 3D objects at the time of comparison are signaled, and “scene file name” and “object_id” which are information for identifying which scene description the 3D object is associated with are signaled and “compareStartTime” and “compareEndTime” which are comparison target time information are signaled as the comparison information of the two 3D objects.

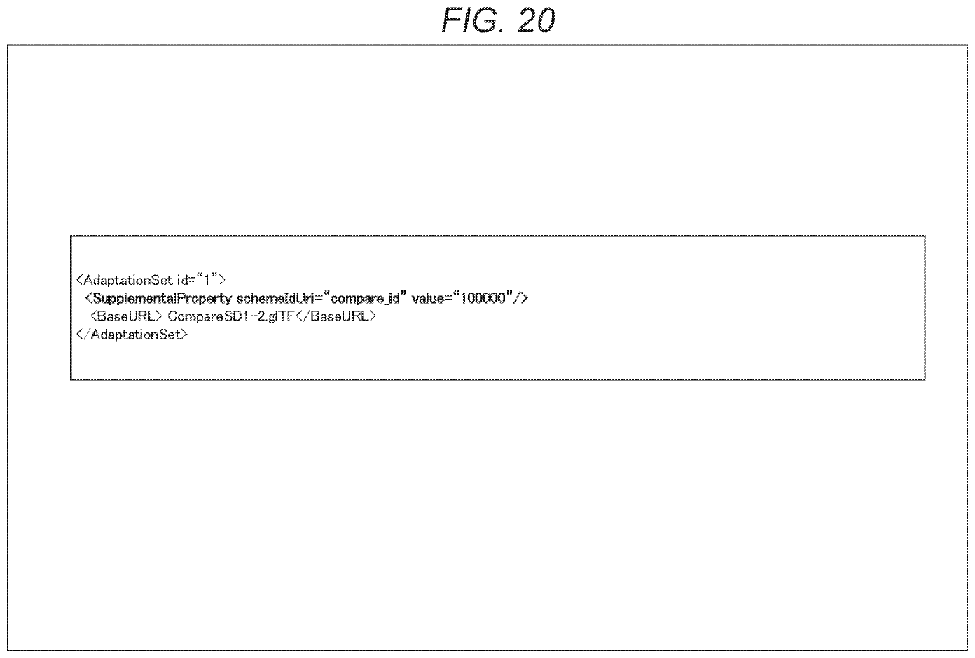

In a case where it is assumed that DASH distribution is performed, it is possible to acquire a scene description for comparison at the beginning of processing by signaling information indicating that the scene description is a scene description for comparison to the MPD. An example of the signal is shown in FIG. 20. As information indicating that the scene description is for comparison, compare_id or the like may be signaled in, for example, supplementalProperty of AdaptationSet including the scene description for comparison.

<Flow of File Generation Process>

The flow of the file generation process in this case is basically similar to the example of FIG. 8. However, in step S103, the comparison information generation unit 124 generates a scene description for comparison and generates comparison information corresponding to the scene description. For example, the comparison information generation unit 124 generates a scene description for comparison including comparison information corresponding to a plurality of comparison target 3D objects. The other processing is performed similarly to the case of FIG. 8.

<Flow of Reproduction Process>

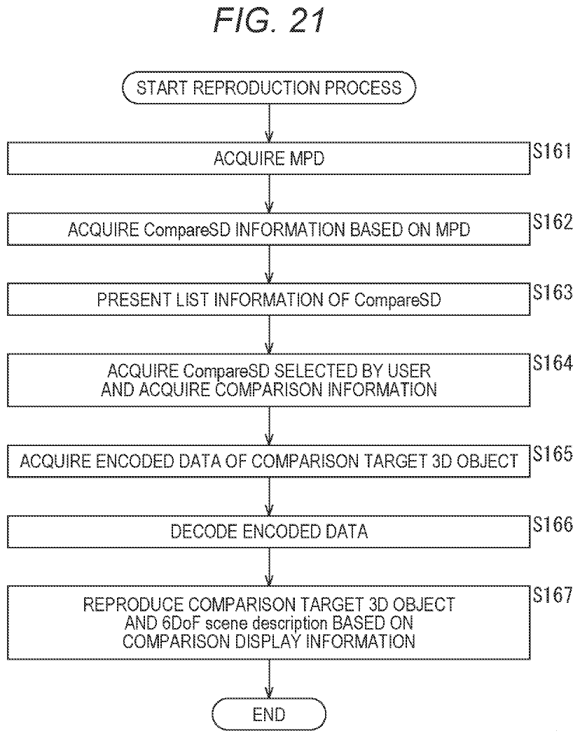

Next, an example of a flow of the reproduction process in this case will be described with reference to the flowchart of FIG. 21.

When the reproduction process is started, in step S161, the MPD processing unit 161 of the client device 103 accesses the server 102 and acquires the MPD of the desired 6DoF content. The MPD processing unit 161 parses the acquired MPD.

In step S162, the comparison information acquisition unit 163 acquires information of a scene description for comparison (compareSD) to be signaled in the MPD on the basis of a result of the parsing.

In step S163, the display unit 169 presents list information of the scene descriptions (compareSD) for comparison to the user on the basis of the information of the scene descriptions (compareSD) for comparison. For example, the display control unit 164 specifies scene descriptions for comparison (compareSD) belonging to the same comparable group on the basis of the “compare_id” indicated in the MPD, generates display control information for displaying a list of the scene descriptions, and supplies the display control information to the buffer 167. The display information generation unit 168 acquires the display control information via the buffer 167, and generates display information including a list of scene descriptions (compareSD) for comparison. The display unit 169 presents a list of scene descriptions (compareSD) for comparison to the user by displaying the display information on the monitor.

The user inputs a selection of a scene description (compareSD) for comparison on the basis of the presented list of scene descriptions (compareSD) for comparison. As described above, by selecting the scene description (compareSD) for comparison, the comparison target 3D object can be selected. An input unit (not illustrated) of the client device 103 receives an input operation by the user or the like. That is, the selection input of the comparison target 3D object by the user or the like is received.

In step S164, the comparison information acquisition unit 163 acquires a scene description (compareSD) for comparison selected by the user, and acquires comparison information from the scene description.

In step S165, the encoded data acquisition unit 165 acquires the encoded data corresponding to the comparison target 3D object selected by the user, that is, the encoded data of the media data of the 3D object. Further, the comparison information acquisition unit 163 acquires a scene description corresponding to the 3D object. Then, the comparison information acquisition unit 163 acquires the comparison display information from the scene description.

In step S166, the decoding unit 166 decodes the encoded data acquired in step S165, and generates (restores) the media data of the comparison target 3D object.

In step S167, the display information generation unit 168 or the like reproduces and displays the comparison target 3D object and the scene description (6DoF scene description) on the basis of the comparison information or the like acquired in step S164 or step S165. For example, the display control unit 164 reproduces and displays the comparison target 3D object and the scene description (6DoF scene description) in a comparable manner on the basis of the comparison display information or the like. As described in the first embodiment, the display control unit 164 controls the display on the basis of each parameter of the comparison display information. The display information generation unit 168 generates display information capable of comparing a plurality of 3D objects according to the display control, and the display unit 169 displays the display information on the monitor. By doing so, a plurality of 3D objects is reproduced and displayed in a comparable manner.

When the process of step S167 ends, the reproduction process ends.

By performing the reproduction process as described above, the client device 103 can more easily reproduce and display the plurality of 3D objects in a comparable manner on the basis of the signaled comparison information. Therefore, the user can more easily compare the 3D objects.

<Distribution Data>

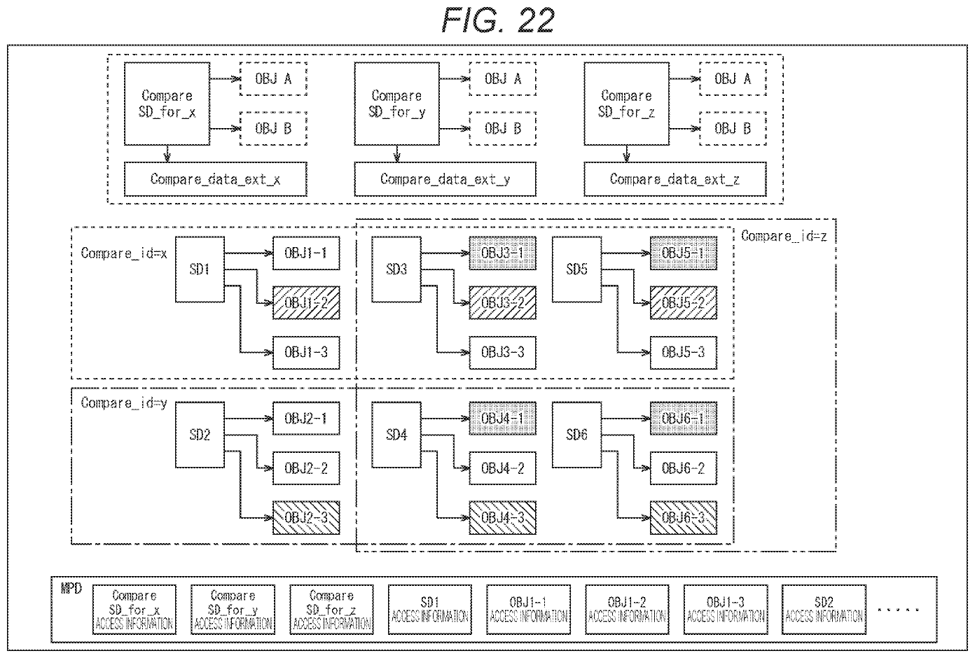

For example, in a case where the comparison scene description is created for the number of combinations of comparison described with reference to FIGS. 18 to 21, it is necessary to create the comparison scene descriptions for all the combinations, and there has been a possibility that overlapping information becomes extremely large. Therefore, as illustrated in FIG. 22, only one scene description for comparison may be created for one comparison group (compare_id), and after the user selects a comparison target 3D object, the 3D object may be associated with the scene description for comparison.

FIG. 22 illustrates that there are 3D objects belonging to any (or a plurality of) of the three comparison groups (compare_id). That is, the scene description for comparison (Compare_SD_for_ext_x) corresponding to the comparison group of compare_id=x, the scene description for comparison (Compare SD_for_ext_y) corresponding to the comparison group of compare_id=y, and the scene description for comparison (Compare SD_for_ext_z) corresponding to the comparison group of compare_id=z are generated. Then, corresponding comparison information is generated. For example, comparison information (Compare_data_ext_x) corresponding to a scene description for comparison (Compare SD_for_ext_x), comparison information (Compare_data_ext_y) corresponding to a scene description for comparison (Compare SD_for_ext_x), and comparison information (Compare_data_ext_z) corresponding to a scene description for comparison (Compare SD_for_ext_z) are generated.

The associated 3D object is not specified at this point, and is linked after being specified by the user.

<Signal Example of Comparison Information>

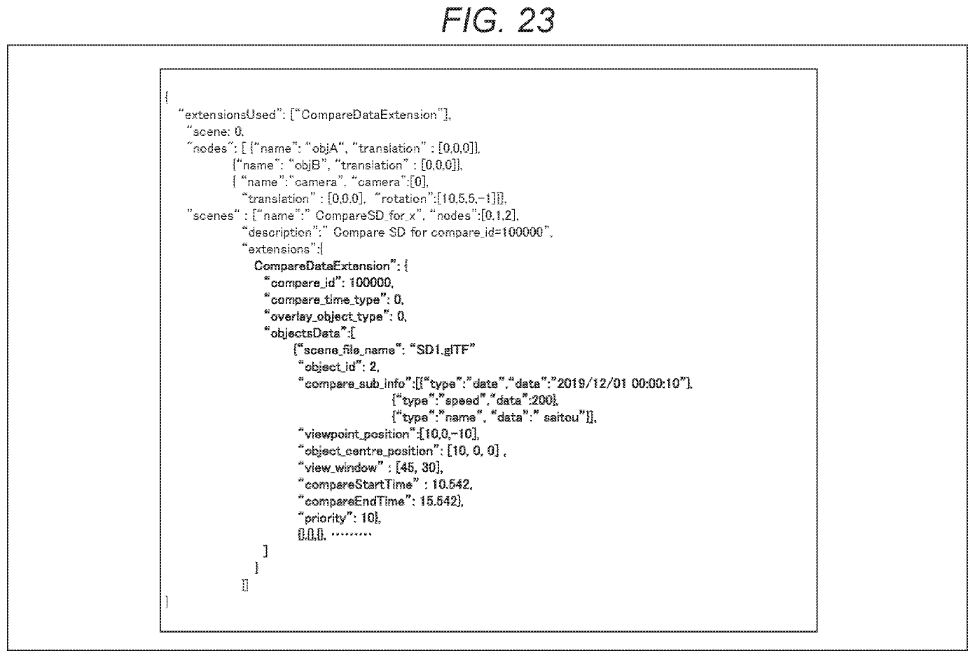

FIG. 23 illustrates an example of signaling of comparison information in a case where such display is performed. This example is also described in glTF 2.0 as in FIG. 6. The description of parts similar to those in the examples described above with reference to FIG. 6 and the like is omitted.

The “scene” described in the scene description for comparison has three “nodes”. Two of the “nodes” are information for arranging the 3D object in association with the “scene”, and have “translation”, “rotation”, “scale”, and the like as the arrangement information. These pieces of arrangement information are signaled such that the arrangement is suitable for comparison. The remaining one “node” is “camera” and has information corresponding to viewpoint position information and view angle information. Up to this point, the functions of the existing glTF 2.0 have been used.

The remaining comparison information is signaled by defining “CompareDataExtension” in “scene” using the extension function of glTF 2.0. Here, “compare_id” which is the comparison identification information, “compare_time_type” indicating a temporal reproduction method of the two 3D objects at the time of comparison are signaled, and “object_overlay_type” indicating the shape of the object to be overlapped is signaled. Comparison display information similar to that described with reference to FIGS. 18 to 21 is signaled as information for each 3D object.

<MPD>

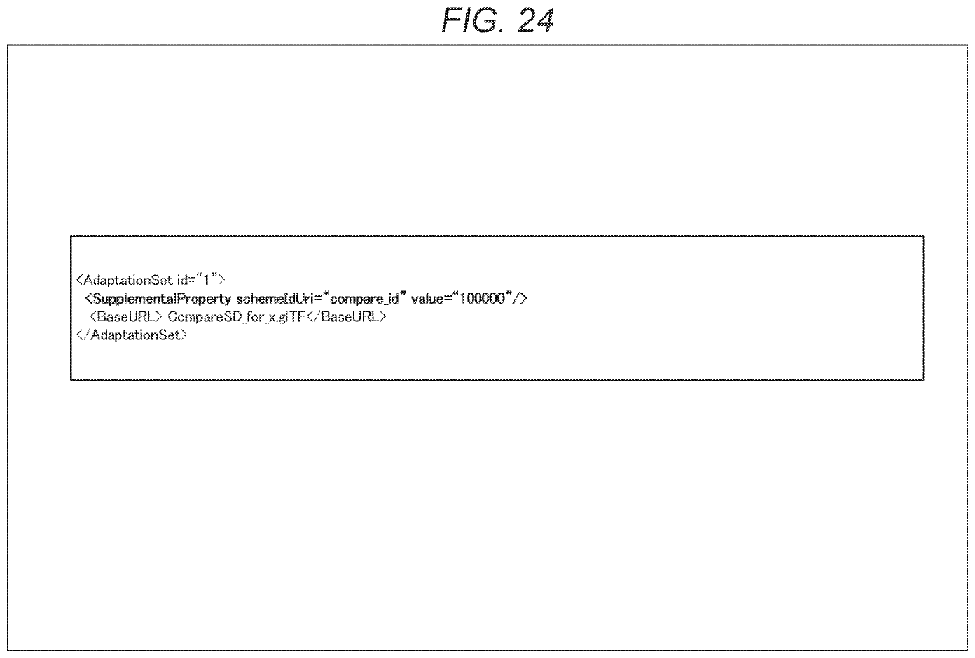

In a case where it is assumed that DASH distribution is performed, it is possible to acquire a scene description for comparison at the beginning of processing by signaling information indicating that the scene description is a scene description for comparison to the MPD. An example of the signal is shown in FIG. 24. As the information indicating the scene description for comparison, “compare_id” or the like may be signaled in a supplemental property or the like of the AdaptationSet including the scene description for comparison.

<Flow of File Generation Process>

The flow of the file generation process in this case is basically similar to the example of FIG. 8. However, in step S103, the comparison information generation unit 124 creates only one scene description for comparison for one comparison group (compare_id). At this point, the 3D object is not associated with the scene description for comparison, and the association is performed at the time of reproduction. For example, the comparison information generation unit 124 generates a scene description for comparison including comparison information corresponding to a group of scene descriptions including a comparable 3D object. The other processing is performed similarly to the case of FIG. 8.

<Flow of Reproduction Process>

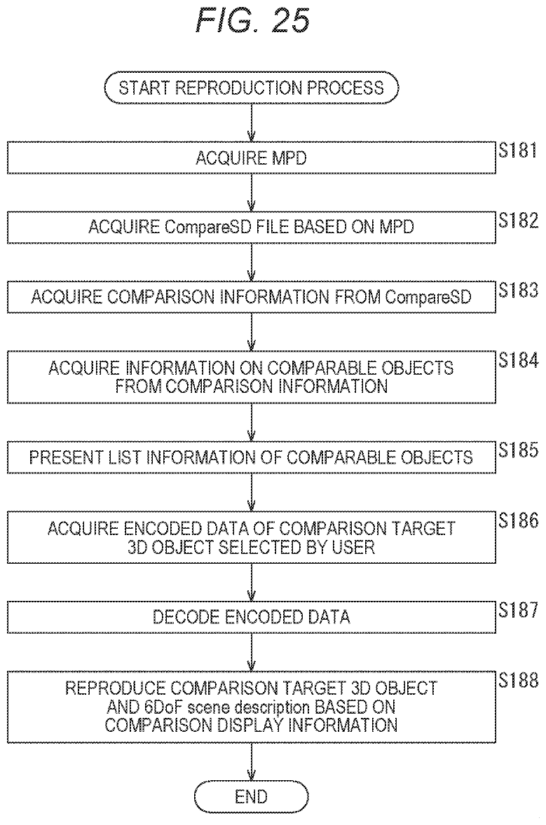

Next, an example of a flow of the reproduction process in this case will be described with reference to the flowchart of FIG. 25.

When the reproduction process is started, in step S181, the MPD processing unit 161 of the client device 103 accesses the server 102 and acquires the MPD of the desired 6DoF content. The MPD processing unit 161 parses the acquired MPD.

In step S182, the comparison information acquisition unit 163 acquires, on the basis of a result of the parsing, file information of a scene description for comparison (compareSD) signaled in the MPD.

In step S183, the comparison information acquisition unit 163 acquires comparison information from the scene description (compareSD) for comparison.

In step S184, the display control unit 164 acquires information of comparable objects from the comparison information.

In step S185, the display unit 169 or the like displays the list information of the comparable objects on the monitor and presents the list information to the user. For example, the display control unit 164 specifies comparable 3D objects belonging to the same comparable group on the basis of “compare_id” indicated in the scene description (compareSD) for comparison, generates display control information for displaying a list of the comparable 3D objects, and supplies the display control information to the buffer 167. The display information generation unit 168 acquires the display control information via the buffer 167, and generates display information including a list of scene descriptions (compareSD) for comparison. The display unit 169 presents a list of comparable 3D objects to the user by displaying the display information on the monitor.

The user inputs selection of a comparison target 3D object on the basis of the presented list. That is, the user selects a comparison target 3D object from the comparable 3D objects. An input unit (not illustrated) of the client device 103 receives an input operation by the user or the like. That is, the selection input of the comparison target 3D object by the user or the like is received.

In step S186, the encoded data acquisition unit 165 acquires the encoded data corresponding to the comparison target 3D object selected by the user, that is, the encoded data of the media data of the 3D object.

In step S187, the decoding unit 166 decodes the encoded data acquired in step S186, and generates (restores) the media data of the comparison target 3D object.

In step S188, the display information generation unit 168 or the like associates the media data of the comparison target 3D object with the scene description (compareSD) for comparison on the basis of the comparison information or the like, and performs reproduction with appropriate display at appropriate timing. The display information generation unit 168 generates display information capable of comparing a plurality of 3D objects according to the display control, and the display unit 169 displays the display information on the monitor. By doing so, a plurality of 3D objects is reproduced and displayed in a comparable manner.

When the process of step S188 ends, the reproduction process ends.

By performing the reproduction process as described above, the client device 103 can more easily reproduce and display the plurality of 3D objects in a comparable manner on the basis of the signaled comparison information. Therefore, the user can more easily compare the 3D objects.

Note that the background used here may be newly prepared, or the same background as the background of the scene description (6DoF scene description) including the comparison target 3D object as a base may be used.

### 5. Third Embodiment

<Signaling of Comparison Viewing Method Information>

The comparison information may include comparison viewing method information that is information specifying a viewing method of the content in which the 3D object is displayed in a comparable manner. In the present embodiment, a method for signaling the comparison viewing method information will be described.

During normal viewing in which the content is viewed from the beginning of the content, presence or absence of recommendation of comparison is indicated as intention of the content author, and information indicating a comparison scenario (for example, the user is caused to select a comparison target from the list display, or the client selects a comparison content according to the priority) in a case where the content is recommended is further signaled.

In the embodiments described above, a scenario is assumed in which, in a case where there is a plurality of comparison targets, a list thereof is displayed, and the user selects a comparison target from the list and displays the comparison target for comparison. In the present embodiment, a case where content is viewed from the beginning (normal viewing) and comparison display is performed during reproduction thereof will be described.

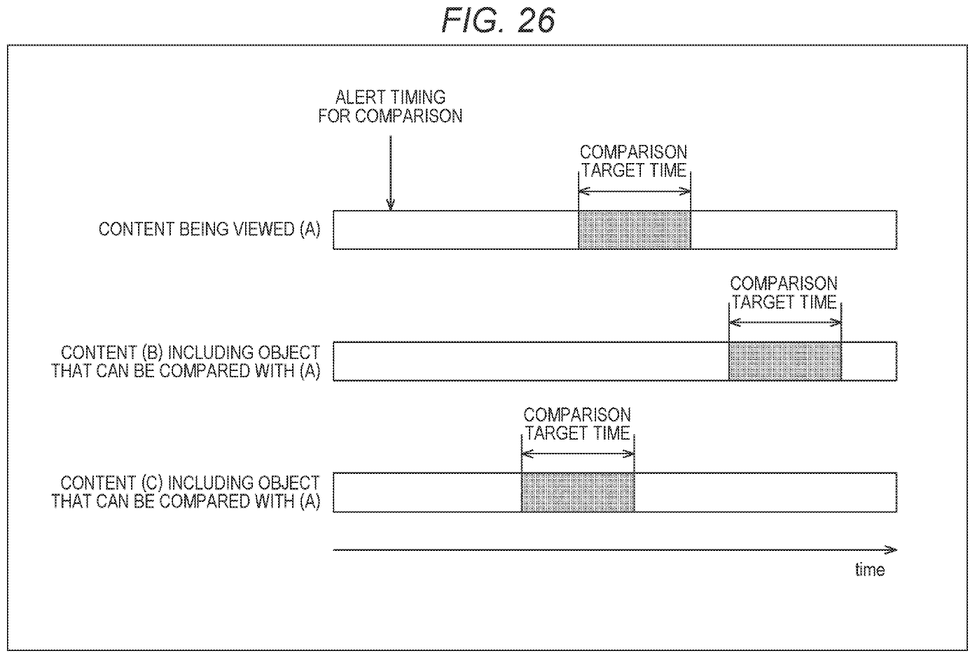

For example, in FIG. 26, it is assumed that content (A) is normally viewed. It is assumed that a comparison target time of a certain 3D object of the content (A) exists at a certain timing. Further, it is assumed that there are content (B) and content (C) including a 3D object that can be compared with the content (A).

Information (comparison identification information) for identifying a 3D object that can be compared with the content (A) and comparison display information can be signaled by each method described in each embodiment.

However, in these signals, there is no method of signaling the intention of the content author as a comparison viewing method of the normal viewing content.

As a comparison viewing method, for example, the following methods can be considered: 1. Comparison is not recommended; 2. Comparison display is based on priority; and 3. Comparison display is selected by the user from a list. Therefore, such comparison viewing method information is signaled. Note that the comparison display list is displayed in “alert timing for comparison” in FIG. 26.

After the comparison target is selected, the comparison display is performed in accordance with the comparison target time of the content being viewed. In a case where the comparison target time ends, a viewing experience such as returning to normal viewing is provided.

<Signal Example of Comparison Information>

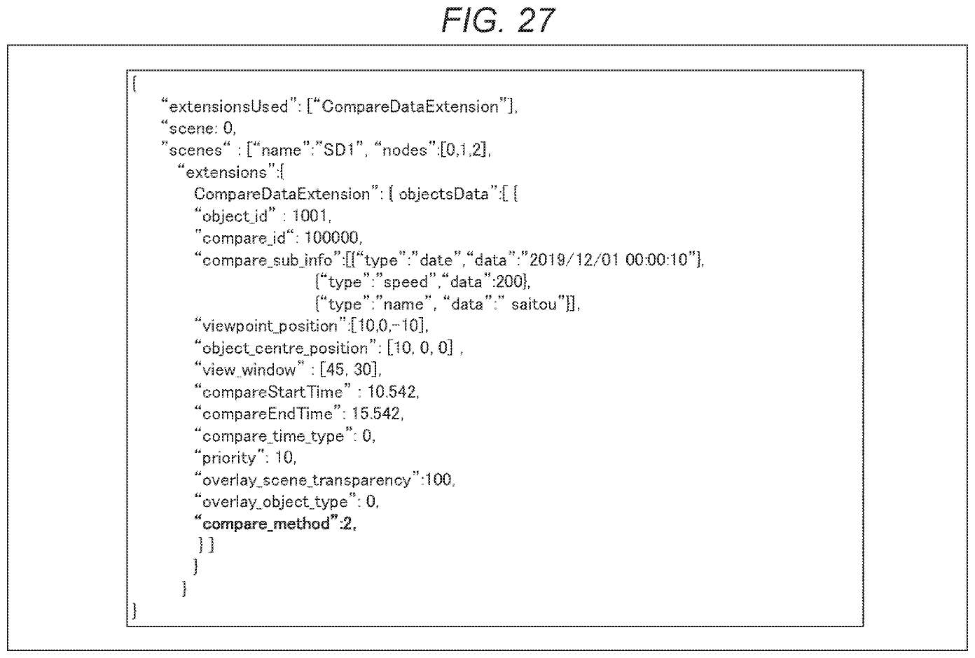

FIG. 27 illustrates an example of signaling of comparison information in a case where such display is performed. This example is also described in glTF 2.0 similarly to FIG. 6 and the like. The description of parts similar to those in the examples described above with reference to FIG. 6 and the like is omitted.

FIG. 27 illustrates an example of signaling the above-described comparison viewing method information in the signal method (as illustrated in FIG. 10, in a case where another 3D object is superimposed and displayed on 6DoF content corresponding to one of the plurality of comparison target 3D objects such that the 3D objects are superimposed and displayed) similar to the example of FIG. 11. As shown in FIG. 27, in this example, “compare_method” is signaled.

The “compare_method” is comparison viewing method information and is information designating a viewing method of the content in which the 3D object is displayed in a comparable manner. A value of “compare_method” or a viewing method designated by “compare_method” is arbitrary. An example thereof will be described below.

0: View as it is without comparison

1: Compare with the highest priority

2: A list of comparable 3D objects is presented, and a user or the like selects and compares the objects.

<MPD>

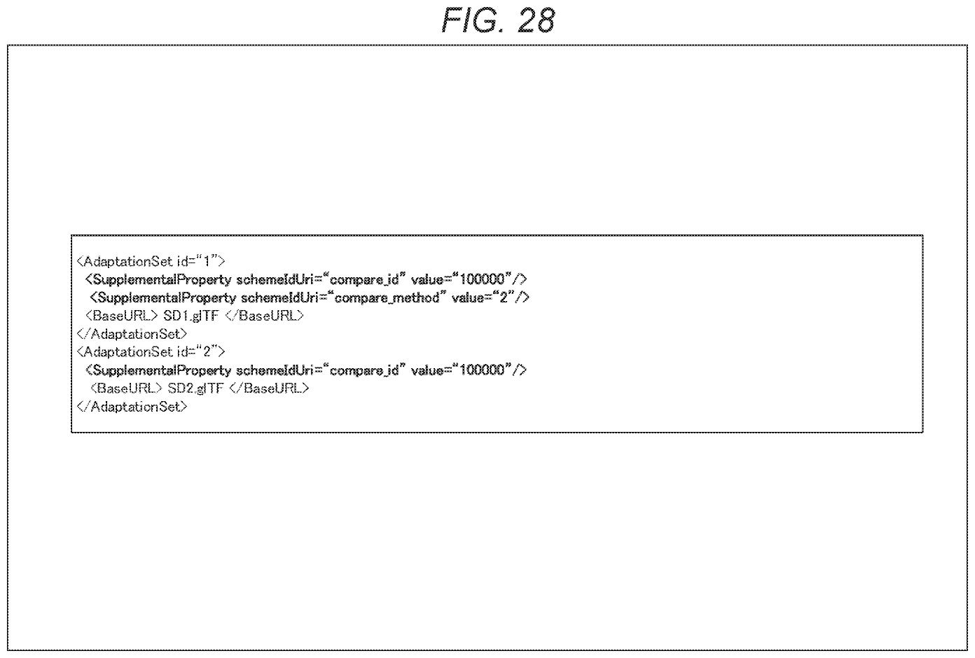

In a case where the DASH distribution is assumed, it is possible to notify the client of the presence or absence of acquisition of other information necessary for comparison by signaling the comparison viewing method information during normal viewing to the MPD. FIG. 28 is a diagram illustrating an example of the MPD in that case. In the case of the example of FIG. 28, “compare_method” is signaled as the comparison viewing method information in the supplemental property or the like of the AdaptationSet including the scene description of the viewing content. Of course, the position to signal the comparison viewing method information is arbitrary and is not limited to the example of FIG. 28.

<Flow of File Generation Process>

The flow of the file generation process in this case is basically similar to the other examples in FIG. 8 and the like. However, in step S103, the comparison information generation unit 124 can generate the above-described comparison viewing method information as the comparison information. The other processing is performed similarly to the other cases in FIG. 8 and the like. In this way, the generation device 101 can indicate the presence or absence of the recommendation of the comparison as the intention of the content author, and further signal the information indicating the comparison scenario in the case of being recommended. By doing so, it is possible to provide a scenario of comparison when there is a comparison target to the reproduction side (the client device 103 or the like) during normal viewing.

<Flow of Reproduction Process>

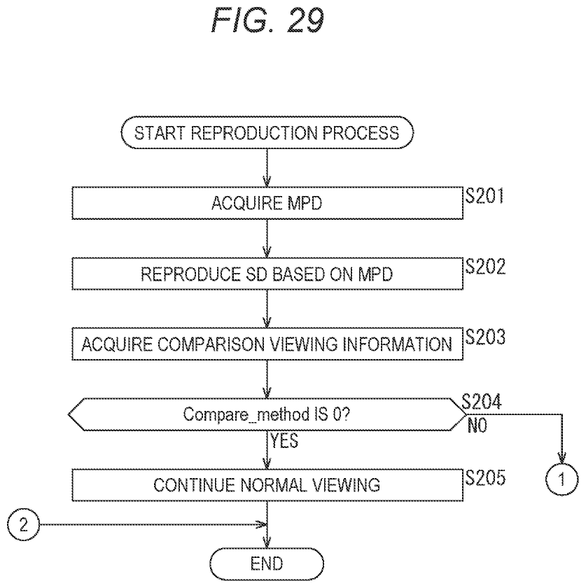

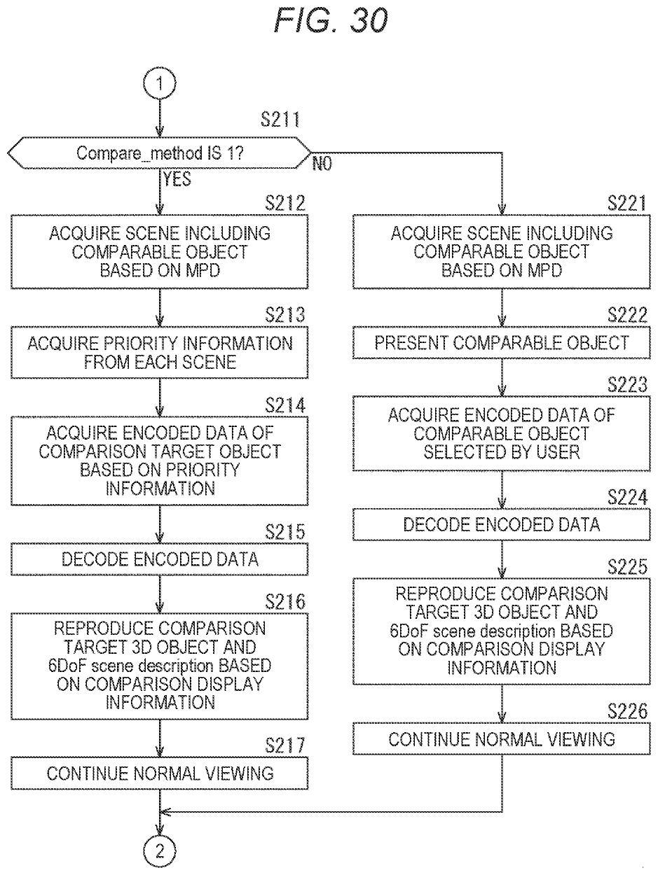

Next, an example of a flow of the reproduction process in this case will be described with reference to the flowcharts of FIGS. 29 and 30.

When the reproduction process is started, in step S201, the MPD processing unit 161 of the client device 103 accesses the server 102 and acquires the MPD of the desired 6DoF content. The MPD processing unit 161 parses the acquired MPD.

In step S202, the comparison information acquisition unit 163 acquires the scene description signaled in the MPD on the basis of the result of the parsing, and reproduces the normal viewing. Further, the comparison information acquisition unit 163 acquires comparison viewing method information corresponding to the content. For example, in a case where the scene description includes the comparison viewing method information, the comparison information acquisition unit 163 acquires the comparison viewing method information from the scene description.

In step S203, the display control unit 164 controls the viewing method on the basis of the comparison viewing method information. For example, the display control unit 164 determines whether or not the value of “compare_method” is “0”. In a case where it is determined that the value of “compare_method” is “0”, the processing proceeds to step S205.

In step S205, the display control unit 164 controls the display so as to continue normal viewing. The display information generation unit 168 generates the display information according to the control, and the display unit 169 displays the display information on the monitor. That is, in this case, normal viewing is continued, and reproduction and display capable of comparing a plurality of 3D objects as described in the first embodiment and the like are not performed.

When the process of step S205 ends, the reproduction process ends. Further, in a case where it is determined in step S204 that the value of “compare_method” is not “0”, the processing proceeds to FIG. 30.

In step S211 of FIG. 30, the display control unit 164 determines whether or not the value of “compare_method” is “1”. In a case where it is determined that the value of “compare_method” is “1”, the processing proceeds to step S212.

In step S212, the comparison information acquisition unit 163 obtains the information of the scene description including the comparable 3D object from the MPD, and acquires the scene description.

In step S213, the data acquisition control unit 162 acquires the priority information from each scene description acquired in step S212.

In step S214, on the basis of the priority level information, the encoded data acquisition unit 165 sets the 3D object having the highest priority level as the comparison target 3D object, and acquires the encoded data of the comparison target 3D object.

In step S215, the decoding unit 166 decodes the acquired encoded data.

In step S216, the comparison information acquisition unit 163 acquires comparison display information. For example, in a case where the scene description includes the comparison display information, the comparison display information is acquired from the scene description. The display control unit 164 reproduces the 3D object and the scene description (6DoF scene description) to be compared on the basis of the comparison display information. The display information generation unit 168 generates the display information according to the control, and the display unit 169 displays the display information on the monitor. That is, in this case, at the comparison target time, reproduction and display capable of comparing a plurality of 3D objects as described in the first embodiment and the like are performed.

Then, when the comparison target time ends, the process returns to the normal reproduction. After returning to the normal reproduction, in step S217, the display control unit 164 controls the display so as to continue the normal viewing. The display information generation unit 168 generates the display information according to the control, and the display unit 169 displays the display information on the monitor.

Then, when the process of step S217 ends, the process returns to FIG. 29, and the reproduction process ends. That is, the normal viewing is continued to the end of the content.

Further, in a case where it is determined in step S211 that the value of “compare_method” is not “1”, the processing proceeds to step S221.

In step S221, the comparison information acquisition unit 163 obtains the information of the comparison information corresponding to the scene description including the comparable 3D object from the MPD, and acquires the comparison information. For example, in a case where the scene description includes comparison information, the comparison information acquisition unit 163 acquires the scene description including a comparable 3D object, and acquires the comparison information from the scene description.

In step S222, the display control unit 164 specifies comparable 3D objects on the basis of the comparison information, and displays a list of the comparable 3D objects. The display information generation unit 168 generates the display information according to the control, and the display unit 169 displays the display information on the monitor. That is, a list of comparable 3D objects is presented to the user or the like. The user or the like selects a comparison target 3D object on the basis of the presentation and inputs the selection. An input unit (not illustrated) of the client device 103 receives the input, that is, selection of the comparison target 3D object by the user or the like.

In step S223, the encoded data acquisition unit 165 acquires the encoded data of the comparison target 3D object selected by the user or the like.

In step S224, the decoding unit 166 decodes the acquired encoded data.

In step S225, the comparison information acquisition unit 163 acquires comparison display information. For example, in a case where the scene description includes the comparison display information, the comparison display information is acquired from the scene description. The display control unit 164 reproduces the 3D object and the scene description (6DoF scene description) to be compared on the basis of the comparison display information. The display information generation unit 168 generates the display information according to the control, and the display unit 169 displays the display information on the monitor. That is, in this case, at the comparison target time, reproduction and display capable of comparing a plurality of 3D objects as described in the first embodiment and the like are performed.

Then, when the comparison target time ends, the process returns to the normal reproduction. After returning to the normal reproduction, in step S226, the display control unit 164 controls the display so as to continue the normal viewing. The display information generation unit 168 generates the display information according to the control, and the display unit 169 displays the display information on the monitor.

Then, when the process of step S226 ends, the process returns to FIG. 29, and the reproduction process ends. That is, the normal viewing is continued to the end of the content.

By performing the reproduction process as described above, the client device 103 can more easily reproduce and display the plurality of 3D objects in a comparable manner on the basis of the signaled comparison information. Further, the client device 103 can achieve more various viewing methods on the basis of the comparison viewing method information. For example, the client device 103 can grasp a comparison scenario when there is a comparison target during normal viewing and provide the comparison scenario to the user. Therefore, the user can more easily compare the 3D objects.

Note that, in a case where the comparison of the content being viewed is started in the middle of the comparison target time, it is also possible to reproduce the comparison target 3D object at the same timing from the middle by using the information of “compareStartTime” and “compareEndTime”.

### 6. Fourth Embodiment

<Signaling of Information Regarding Thumbnail>

For example, in a case where the list of scene descriptions and the like described above is displayed, a moving image or a still image with a low resolution such as a 3D object corresponding to each scene description and the like (that is, each option) may be displayed as a thumbnail. In order to easily realize such thumbnail display in the client device 103, information regarding the thumbnail may be signaled. In the present embodiment, a method of signaling information regarding the thumbnail will be described.

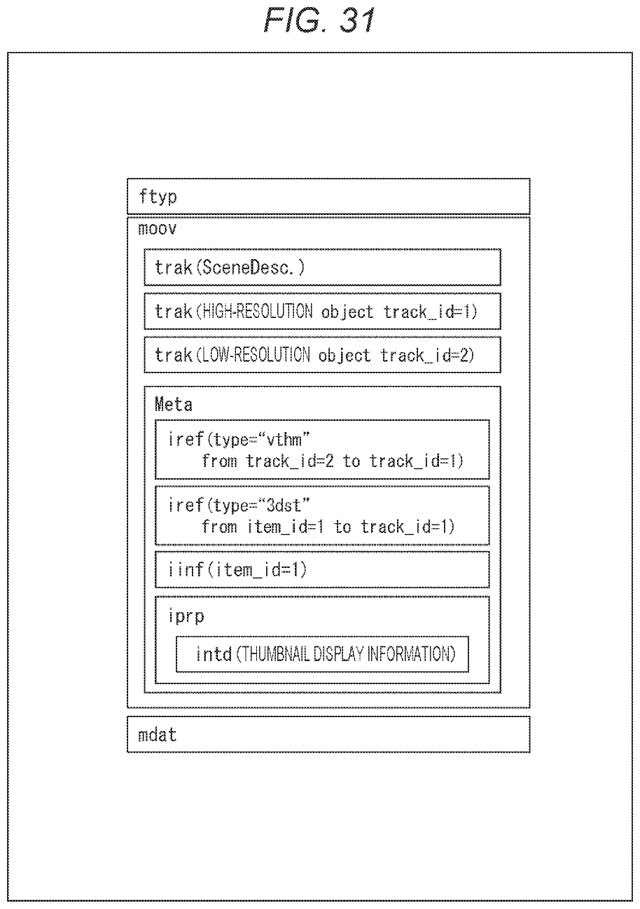

There is a technique for indicating a reference relationship between a high-resolution 3D object and a 3D object (low-resolution 3D video or a 3D object of a still image) used as a thumbnail of the 3D object in the “meta” box of ISOBMFF. FIG. 31 illustrates a configuration example of ISOBMFF indicating the reference relationship.

In the example of FIG. 31, in the “moov” BOX, three “trak” BOXs for signaling information of each track including a scene description, a high-resolution 3D object (original video), and a low-resolution 3D object to be used as a thumbnail, and a “meta” BOX including a “iinf” BOX indicating information of a 3D object of a still image to be used as a thumbnail are signaled.

In the “iref” BOX, a reference relationship between a track or item including a thumbnail and the original image is illustrated. Moreover, information (also referred to as thumbnail display information) such as the first viewpoint position, line-of-sight direction, and view angle information of the thumbnail, and display rule information (information signaling a change in position information with time) is stored as Item Property (“intd” or the like), and is associated with a track or item including the thumbnail.

In such ISOBMFF, when a list of comparison target 3D objects is displayed as thumbnails, information regarding the thumbnails is signaled. The information regarding the thumbnail may be any information as long as it relates to the thumbnail. For example, the thumbnail display information included in ISOBMFF, the information indicating that the comparison display information included in the comparison information is used, or the like may be included.

<Signal Example of Information Regarding Thumbnail>

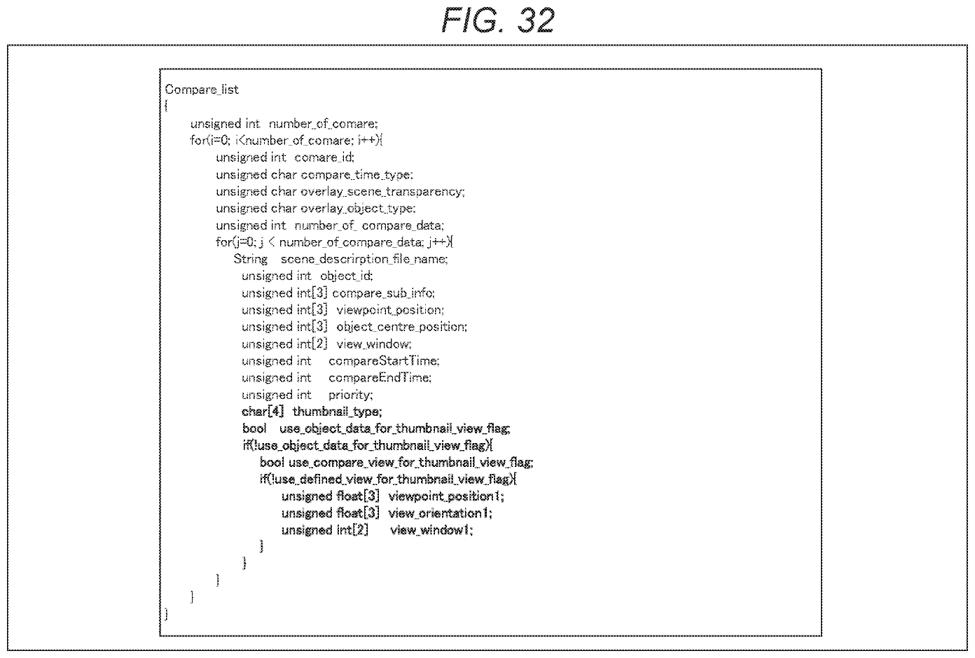

FIG. 32 illustrates an example of signaling of information regarding the thumbnail in a case where such display is performed. This example is described by binary data as in the case of FIG. 15. Description of parts similar to the parameters described with reference to FIG. 15 will be omitted. In this example, “thumbnail_type”, “use_object_data_for_thumbnail_view_flag”, and “use_compare_view_for_thumbnail_view_flag” are signaled as the information regarding the thumbnail.

The “thumbnail_type” is information indicating which type of thumbnail is used among the stored thumbnails. For example, in the case of FIG. 31, “vthm” that is a 3D object of a low-resolution moving image and “3dst” that is a 3D object of a still image are stored (“iinf” BOX). Thus, “thumbnail_type” signals any of these. Of course, the type of thumbnail is arbitrary and is not limited to the example of FIG. 31.

The “use_object_data_for_thumbnail_view_flag” is flag information indicating whether the thumbnail display information stored in the 3D object of the thumbnail is diverted when the thumbnail is displayed. In a case where the “use_object_data_for_thumbnail_view_flag” is “true”, the thumbnail display information stored in the 3D object is diverted. On the other hand, in a case where “use_object_data_for_thumbnail_view_flag” is “false”, the thumbnail display information is not diverted, and “use_compare_view_for_thumbnail_view_flag” is further signaled.

The “use_compare_view_for_thumbnail_view_flag” is flag information indicating whether to divert the information for comparison display. In a case where “use_compare_view_for_thumbnail_view_flag” is “true”, “viewpoint position”, “view_orientation”, “view_window”, and the like of the above-described comparison display information are diverted. Further, in a case where “use_compare_view_for_thumbnail_view_flag” is “false”, these pieces of information are separately signaled.

By signaling such information regarding the thumbnail, for example, it is possible to provide the client device 103 with information such as designation of the thumbnail at the time of list display and diversion of the display method of the thumbnail included in the thumbnail 3D object. As a result, the client device 103 can easily display the thumbnail of the 3D object or the like corresponding to each scene description or the like on the basis of the information regarding the thumbnail when displaying the list of scene descriptions or the like.

### 7. Fifth Embodiment

<Signaling of Comparison Display Information that Changes Dynamically>

The above-described comparison display information can be dynamically changed in the time direction, for example. In the present embodiment, a signal method for dynamically changing the comparison display information in this manner will be described.

<Signal Example of Comparison Information>

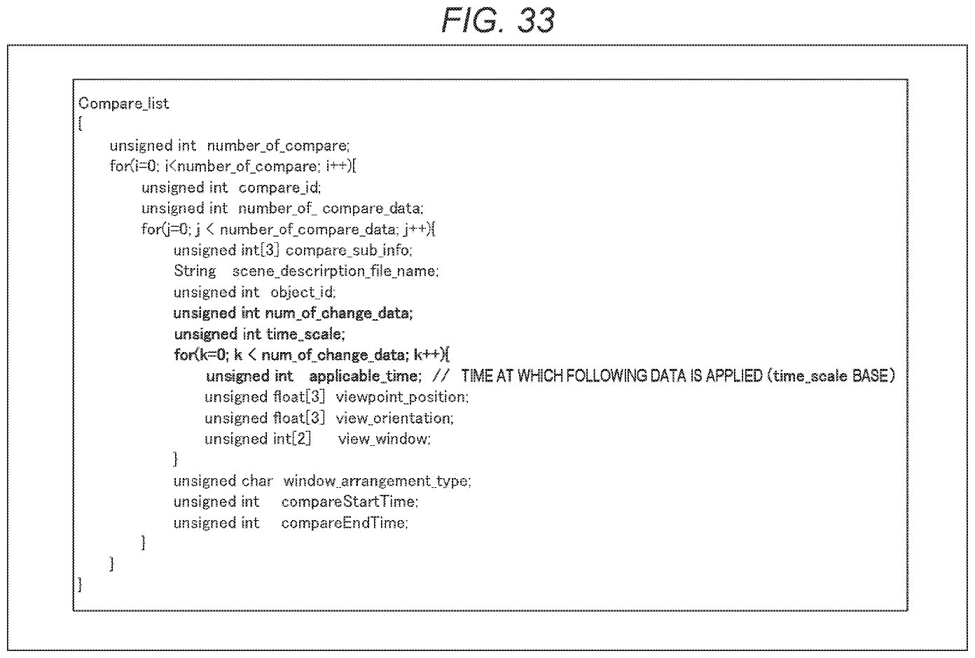

FIG. 33 illustrates an example of signaling of information for dynamically changing the comparison display information. Similarly to FIG. 15 and FIG. 32, this example is described by binary data. This example is extended so as to be able to store information that changes the compare list with time in a case where the compare list as described in the second embodiment is signaled. In this example, “num_of_change_data”, “time_scale”, and “applicable_time” are signaled as information for changing compare_list with time.

“num_of_change_data” is information indicating the number of pieces of data that change with time, and “time_scale” is time scale information used for time information. The “applicable_time” is information indicating a time at which data is applied. Then, “viewpoint_position”, “view_orientation”, and “view_window” are signaled as the comparison display information of the time indicated by the “applicable_time”. That is, these pieces of comparison display information are applied at the time indicated by “applicable_time” (the time in the time scale indicated by “time_scale”). This process is looped “num_of_change_data” times.

By performing such signaling, the client device 103 can dynamically change the comparison display information.

It is noted that, for such data that changes with time, a method of storing timed meta data in ISOBMFF may be used.

<Another Example of Signaling of Comparison Display Information that Changes Dynamically>

The signal method for dynamically changing the comparison display information is not limited to the above example. Another method will be described on the basis of the example of the signaling of the first embodiment.

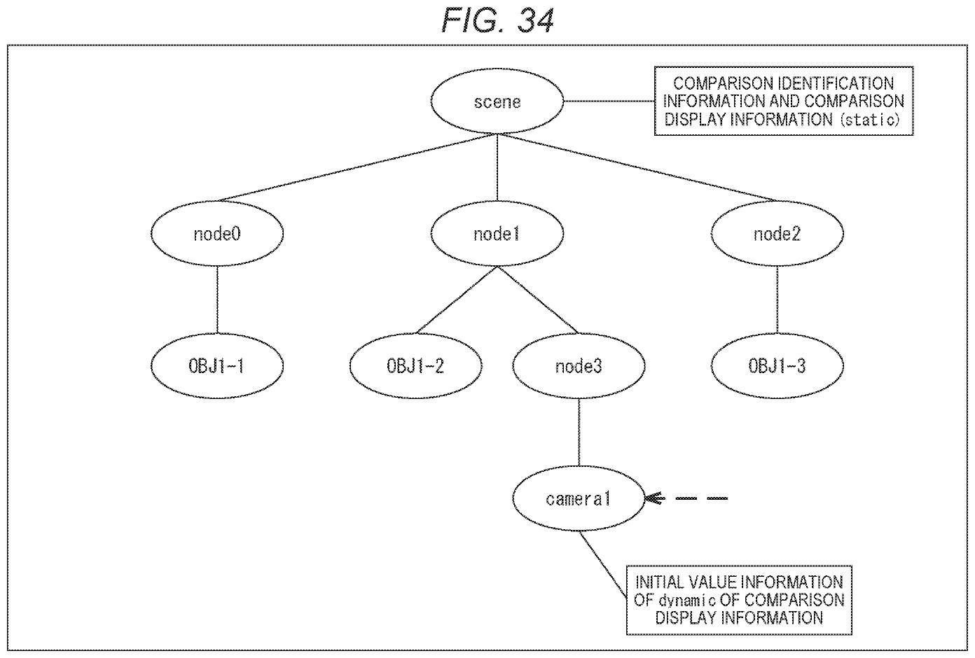

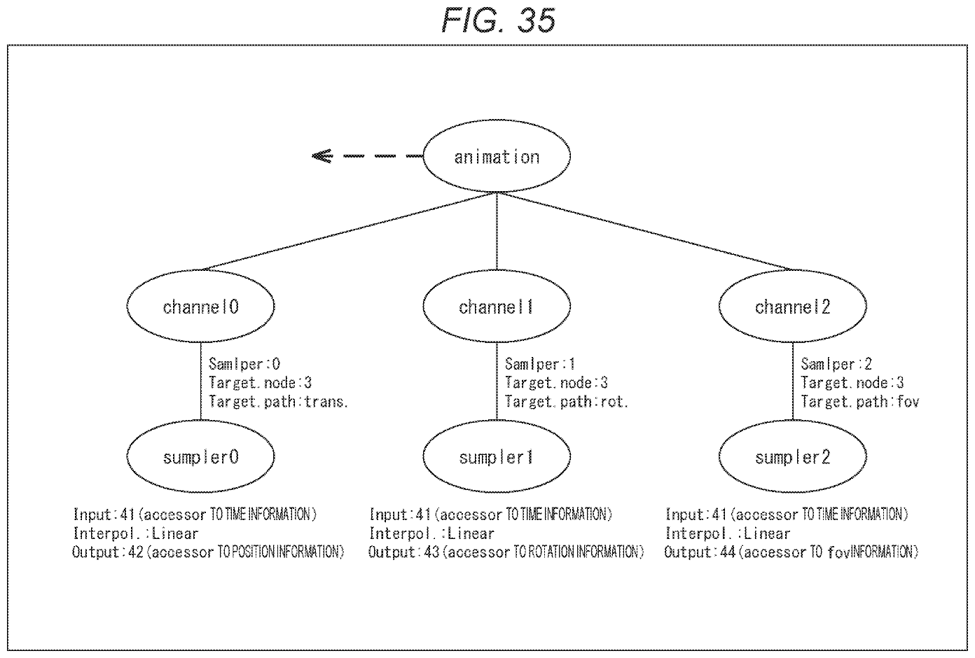

FIGS. 34 and 35 are diagrams illustrating an example of a concept at the time of signaling the comparison display information that changes with time using the mechanism of the glTF 2.0.

Similarly to the case of the first embodiment, static data of the comparison identification information and the comparison display information is signaled while extension is defined in “scene” (FIG. 34). On the other hand, the initial value information of the dynamic data (dynamic) of the comparison information is signaled using “node” having “camera” of glTF 2.0. The comparison display information and the 3D object are associated with each other by associating the “camera” with the comparison target 3D object (Obj1-2 in FIG. 34).

Data that changes after the initial value is signaled by “animation” of glTF 2.0 associated with “node” having “camera”. The dotted arrow from “animation” in FIG. 35 corresponds to the dotted arrow toward “cameral” in FIG. 34.

“Channel” belonging to “animation” in FIG. 35 has information (channel.target.node) of “node” to be target and information (channel.target.path) indicating what kind of change is used, and can specify association with “node” and a type of movement.

Only “transration”, “rotation”, “scale”, and “weight” can be specified as parameters in channel.target.path of the current glTF 2.0. In order to change the field of view (FOV) of the camera, extension such as enabling designation of “fov” in this parameter may be performed.

The “sampler” has reference information to “accessor” having access information to a file that stores animation data.

<Signal Example of Comparison Information>

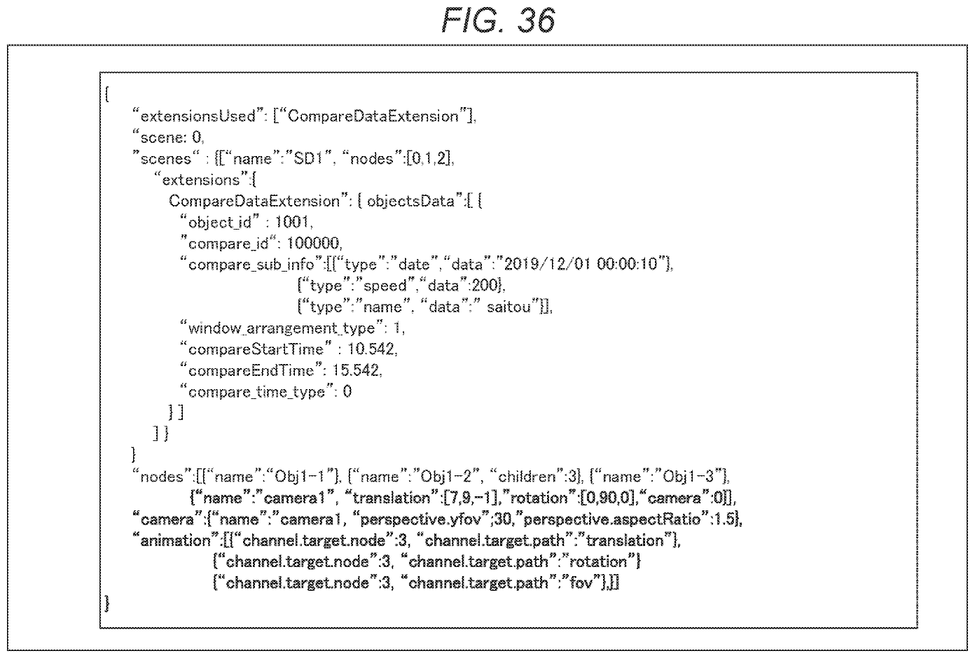

FIG. 36 illustrates an example of such signaling of the dynamically changing comparison display information. This example is also described in glTF 2.0 similarly to FIG. 6 and the like. In the case of this example, the initial information of the dynamic comparison display information is indicated by “translation” and “rotation” of “node” associated with a “camera” object, with “camera” as a child node in “Obj1-2”. These pieces of information are used as initial values of the viewpoint position and the line-of-sight direction. Further, the view angle information is signaled by designating “perspective.yfov” and “perspective.aspectRatio” of “camera”.

The dynamic information after the initial information is signaled so that the “animation” has three “channels” and “translation”, “rotation”, and “fov” are designated as respective channel.target.path to access the dynamic information of these items.

By performing such signaling, it is possible to provide the dynamically changing comparison display information to the reproduction side (the client device 103 or the like). As a result, the client device 103 can dynamically change the comparison display information.

### 8. Appendix

<Computer>

The above-described series of processing can be executed by hardware or software. In a case where the series of processing is executed by software, a program constituting the software is installed in a computer. Here, the computer includes a computer incorporated in dedicated hardware, a general-purpose personal computer capable of executing various functions by installing various programs, and the like, for example.

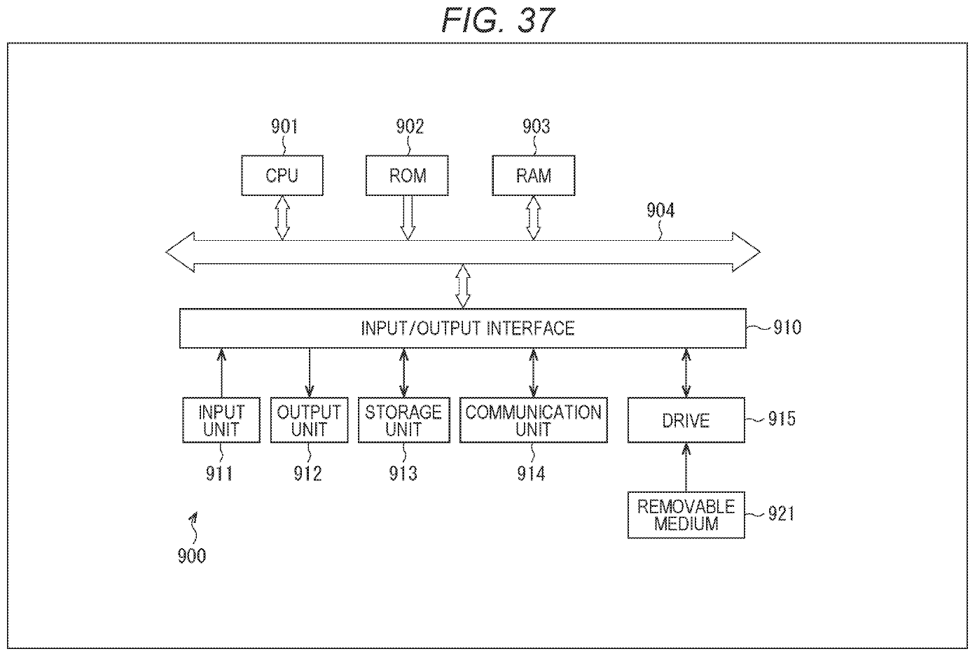

FIG. 37 is a block diagram illustrating a configuration example of hardware of a computer that executes the above-described series of processing by a program.

In a computer 900 illustrated in FIG. 37, a central processing unit (CPU) 901, a read only memory (ROM) 902, and a random access memory (RAM) 903 are mutually connected via a bus 904.

An input/output interface 910 is also connected to the bus 904. An input unit 911, an output unit 912, a storage unit 913, a communication unit 914, and a drive 915 are connected to the input/output interface 910.

The input unit 911 includes, for example, a keyboard, a mouse, a microphone, a touch panel, an input terminal, and the like. The output unit 912 includes, for example, a display, a speaker, an output terminal, and the like. The storage unit 913 includes, for example, a hard disk, a RAM disk, a nonvolatile memory, and the like. The communication unit 914 includes, for example, a network interface. The drive 915 drives a removable medium 921 such as a magnetic disk, an optical disk, a magneto-optical disk, or a semiconductor memory.

In the computer configured as described above, for example, the CPU 901 loads a program stored in the storage unit 913 into the RAM 903 via the input/output interface 910 and the bus 904 and executes the program, whereby the above-described series of processing is performed. The RAM 903 also appropriately stores data and the like necessary for the CPU 901 to execute various processes.

The program executed by the computer can be applied by being recorded in the removable medium 921 as a package medium or the like, for example. In this case, the program can be installed in the storage unit 913 via the input/output interface 910 by attaching the removable medium 921 to the drive 915.

Further, this program can also be provided via a wired or wireless transmission medium such as a local area network, the Internet, or digital satellite broadcasting. In this case, the program can be received by the communication unit 914 and installed in the storage unit 913.

This program can be installed in the ROM 902 or the storage unit 913 in advance.

<Control Information>

The control information related to the present technology described in each of the above embodiments may be transmitted from the encoding side to the decoding side. For example, control information (for example, enabled_flag) for controlling whether or not to permit (or prohibit) the application of the present technology described above may be transmitted. Further, for example, control information (for example, present_flag) indicating an object to which the above-described present technology is applied (or an object to which the present technology is not applied) may be transmitted. For example, control information specifying a block size (Upper limit or lower limit or both), a frame, a component, a layer, or the like to which the present technology is applied (or permit or prohibit the application) may be transmitted.

### Object to which Present Technology is Applied

The present technology can be applied to any image encoding/decoding method. That is, as long as there is no contradiction with the present technology described above, specifications of various processes related to image encoding/decoding such as transformation (inverse transformation), quantization (inverse quantization), encoding (decoding), and prediction are arbitrary, and are not limited to the examples described above. Further, as long as there is no contradiction with the present technology described above, some of these processes may be omitted.

The present technology can be applied to a multi-view image encoding/decoding system that encodes/decodes a multi-view image including images of a plurality of viewpoints (views). In that case, it is sufficient that the present technology is applied to encoding and decoding of each viewpoint (view).

The present technology can be applied to a hierarchical image encoding (scalable encoding)/decoding system that encodes/decodes a hierarchical image multi-layered (hierarchized) so as to have a scalability function for a predetermined parameter. In that case, it is sufficient that the present technology is applied to encoding and decoding of each layer (layer).

Further, although the generation device 101 and the client device 103 have been described above as application examples of the present technology, the present technology can be applied to an arbitrary configuration.

For example, the present technology can be applied to various electronic devices such as a transmitter and a receiver (for example, a television receiver and a mobile phone) in satellite broadcasting, cable broadcasting such as cable TV, distribution on the Internet, and distribution to a terminal by cellular communication, or a device (for example, a hard disk recorder and a camera) that records an image on a medium such as an optical disk, a magnetic disk, and a flash memory, or reproduces an image from the storage medium.

Further, for example, the present technology can also be implemented as a partial configuration of an apparatus, such as a processor (for example, a video processor) as a system large scale integration (LSI) or the like, a module (for example, a video module) using a plurality of processors or the like, a unit (for example, a video unit) using a plurality of modules or the like, or a set (for example, a video set) obtained by further adding other functions to a unit.

Further, for example, the present technology can also be applied to a network system including a plurality of devices. For example, the present technology may be implemented as cloud computing shared and processed in cooperation by a plurality of devices via a network. For example, the present technology may be implemented in a cloud service that provides a service related to an image (moving image) to an arbitrary terminal such as a computer, an audio visual (AV) device, a portable information processing terminal, or an Internet of Things (IoT) device.

Note that, in the present specification, a system means a set of a plurality of components (Devices, modules (parts), etc.), and it does not matter whether or not all the components are in the same housing.

Therefore, a plurality of devices housed in separate housings and connected via a network and one device in which a plurality of modules is housed in one housing are both systems.

### Field and Application to which Present Technology is Applicable

The system, the device, the processing unit, and the like to which the present technology is applied can be used in arbitrary fields such as traffic, medical care, crime prevention, agriculture, livestock industry, mining, beauty, factory, home appliance, weather, and natural monitoring. Further, the application thereof is also arbitrary.

For example, the present technology can be applied to a system or a device provided for providing content for appreciation or the like. Further, for example, the present technology can also be applied to systems and devices provided for traffic, such as traffic condition supervision and automatic driving control. Further, for example, the present technology can also be applied to a system or a device provided for security. Further, for example, the present technology can be applied to a system or a device provided for automatic control of a machine or the like. Further, for example, the present technology can also be applied to systems and devices used for agriculture and livestock industry. Moreover, the present technology can also be applied to a system and a device that monitor natural states such as volcanoes, forests, and oceans, wildlife, and the like. Furthermore, for example, the present technology can also be applied to systems and devices provided for sports.

### Others

Note that, in the present specification, the “flag” is information for identifying a plurality of states, and includes not only information used for identifying two states of true (1) and false (0) but also information capable of identifying three or more states. Therefore, the value that can be taken by the “flag” may be, for example, a binary of I/O or a ternary or more. That is, the number of bits constituting this “flag” is arbitrary, and may be one bit or a plurality of bits. Further, since the identification information (including the flag) is assumed to include not only the identification information in the bit stream but also the difference information of the identification information with respect to certain reference information in the bit stream, in the present specification, the “flag” and the “identification information” include not only the information but also the difference information with respect to the reference information.

Further, various types of information (metadata and the like) related to the encoded data (bit stream) may be transmitted or recorded in any form as long as the information is associated with the encoded data. Here, the term “associate” means, for example, that one data can be used (linked) when the other data is processed. That is, the data associated with each other may be collected as one data or may be individual data. For example, information associated with encoded data (image) may be transmitted on a transmission path different from that of the encoded data (image). Further, for example, the information associated with the encoded data (image) may be recorded in a recording medium (or another recording area of the same recording medium) different from the encoded data (image). Note that this “association” may be a part of data instead of the entire data. For example, an image and information corresponding to the image may be associated with each other in an arbitrary unit such as a plurality of frames, one frame, or a part in a frame.

Note that, in the present specification, terms such as “combine”, “multiplex”, “add”, “integrate”, “include”, “store”, “insert”, and “insert” mean to combine a plurality of items into one, for example, to combine encoded data and metadata into one data, and mean one method of the above-described “associate”.

Further, the embodiments of the present technology are not limited to the above-described embodiments, and various modifications can be made without departing from the gist of the present technology.

For example, a configuration described as one device (or processing unit) may be divided and configured as a plurality of devices (or processing units). Conversely, configurations described above as a plurality of devices (or processing units) may be collectively configured as one device (or processing unit). Further, a configuration other than the above-described configuration may be added to the configuration of each device (or each processing unit). Further, as long as the configuration and operation of the entire system are substantially the same, a part of the configuration of a certain device (or processing unit) may be included in the configuration of another device (or another processing unit).

Further, for example, the above-described program may be executed in an arbitrary device. In that case, it is sufficient that the device has a necessary function (functional block or the like) and can obtain necessary information.

Further, for example, each step of one flowchart may be executed by one device, or may be shared and executed by a plurality of devices. Further, in a case where a plurality of processes is included in one step, the plurality of processes may be executed by one device, or may be shared and executed by a plurality of devices. In other words, a plurality of processes included in one step can also be executed as processes of a plurality of steps. Conversely, the processing described as a plurality of steps can be collectively executed as one step.

Further, for example, in the program executed by the computer, processing of steps describing the program may be executed in time series in the order described in the present specification, or may be executed in parallel or individually at necessary timing such as when a call is made. That is, as long as there is no contradiction, the processing of each step may be executed in an order different from the above-described order. Further, the processing of steps describing this program may be executed in parallel with the processing of another program, or may be executed in combination with the processing of another program.

Further, for example, a plurality of techniques related to the present technology can be implemented independently as a single body as long as there is no contradiction. Of course, a plurality of arbitrary present technologies can be implemented in combination. For example, some or all of the present technology described in any of the embodiments can be implemented in combination with some or all of the present technology described in other embodiments. Further, some or all of the above-described arbitrary present technology can be implemented in combination with other technologies not described above.

Note that the present technology can also have the following configurations.

(1) An information processing apparatus including:

a comparison information generation unit that generates comparison information which is information for displaying a plurality of 3D objects of 6DoF content in a comparable manner.

(2) The information processing apparatus according to (1), in which

the comparison information includes comparison identification information that is information regarding a comparison target 3D object.

(3) The information processing apparatus according to (1), in which

the comparison information includes comparison display information that is information regarding display of the 3D object.

(4) The information processing apparatus according to (1), in which

the comparison information includes comparison control information that is information for listing the comparison information regarding the plurality of 3D objects.

(5) The information processing apparatus according to (1), in which

the comparison information includes comparison viewing method information which is information regarding a viewing method of the 6DoF content.

(6) The information processing apparatus according to (1), in which

the comparison information is configured for each of the 3D objects.

(7) The information processing apparatus according to (1), in which

the comparison information includes information for displaying the 6DoF content corresponding to each of the plurality of comparison target 3D objects side by side.

(8) The information processing apparatus according to (1), in which

the comparison information includes information for superimposing another 3D object on the 6DoF content corresponding to one of the plurality of comparison target 3D objects so that the 3D objects are displayed in a superimposed manner.

(9) The information processing apparatus according to (1), in which

the comparison information includes information for superimposing another 3D object on the 6DoF content corresponding to one of the plurality of comparison target 3D objects so that the 3D objects are displayed side by side.

(10) The information processing apparatus according to (1), in which

the comparison information generation unit generates a scene description including the comparison information.

(11) The information processing apparatus according to (1), in which

the comparison information generation unit generates the comparison information corresponding to a plurality of scene descriptions.

(12) The information processing apparatus according to (1), in which

the comparison information generation unit generates a scene description for comparison including the comparison information corresponding to the plurality of comparison target 3D objects.

(13) The information processing apparatus according to (1), in which

the comparison information generation unit generates a scene description for comparison including the comparison information corresponding to a group of scene descriptions including the 3D objects that can be compared.

(14) The information processing apparatus according to (1), further including:

an MPD generation unit that generates a media presentation description (MPD) including the comparison information.

(15) An information processing method for generating

comparison information which is information for displaying a plurality of 3D objects of 6DoF content in a comparable manner.

### REFERENCE SIGNS LIST

100 Distribution system
101 Generation device
102 Server
103 Client device
111 Control unit
112 Generation processing unit
121 Data input unit
122 Preprocessing unit
123 Encoding unit
124 Comparison information generation unit
125 File generation unit
126 MPD generation unit
127 Storage unit
128 Upload unit
151 Control unit
152 Reproduction processing unit
161 MPD processing unit
162 Data acquisition control unit
163 Comparison information acquisition unit
164 Display control unit
165 Encoded data acquisition unit
166 Decoding unit
167 Buffer
168 Display information generation unit
169 Display unit

1. An information processing apparatus comprising:
a comparison information generation unit that generates comparison information which is information for displaying a plurality of 3D objects of 6DoF content in a comparable manner.

2. The information processing apparatus according to claim 1, wherein
the comparison information includes comparison identification information that is information regarding a comparison target 3D object.

3. The information processing apparatus according to claim 1, wherein
the comparison information includes comparison display information that is information regarding display of the 3D object.

4. The information processing apparatus according to claim 1, wherein
the comparison information includes comparison control information that is information for listing the comparison information regarding the plurality of 3D objects.

5. The information processing apparatus according to claim 1, wherein
the comparison information includes comparison viewing method information which is information regarding a viewing method of the 6DoF content.

6. The information processing apparatus according to claim 1, wherein
the comparison information is configured for each of the 3D objects.

7. The information processing apparatus according to claim 1, wherein
the comparison information includes information for displaying the 6DoF content corresponding to each of the plurality of comparison target 3D objects side by side.

8. The information processing apparatus according to claim 1, wherein
the comparison information includes information for superimposing another 3D object on the 6DoF content corresponding to one of the plurality of comparison target 3D objects so that the 3D objects are displayed in a superimposed manner.

9. The information processing apparatus according to claim 1, wherein
the comparison information includes information for superimposing another 3D object on the 6DoF content corresponding to one of the plurality of comparison target 3D objects so that the 3D objects are displayed side by side.

10. The information processing apparatus according to claim 1, wherein
the comparison information generation unit generates a scene description including the comparison information.

11. The information processing apparatus according to claim 1, wherein
the comparison information generation unit generates the comparison information corresponding to a plurality of scene descriptions.

12. The information processing apparatus according to claim 1, wherein
the comparison information generation unit generates a scene description for comparison including the comparison information corresponding to the plurality of comparison target 3D objects.

13. The information processing apparatus according to claim 1, wherein
the comparison information generation unit generates a scene description for comparison including the comparison information corresponding to a group of scene descriptions including the 3D objects that can be compared.

14. The information processing apparatus according to claim 1, further comprising:
an MPD generation unit that generates a media presentation description (MPD) including the comparison information.

15. An information processing method for generating
comparison information which is information for displaying a plurality of 3D objects of 6DoF content in a comparable manner.
